(19) United States
(12) Patent Application Publication
(10) Pub. No.: US 2023/0207796 A1
(43) Pub. Date: Jun. 29, 2023

(54) ZINC SECONDARY BATTERY

(71) Applicant: NGK INSULATORS, LTD., Nagoya-City (JP)

(72) Inventors: Junki MATSUYA, Chitagun (JP); Yuichi GONDA, Nagoya-City (JP); Takeshi YAGI, Toyohashi-City (JP); Kenshin KITOH, Nagoya-City (JP); Shohei YOKOYAMA, Nagoya-City (JP); Naoko INUKAI, Nagoya-City (JP); Sho YAMAMOTO, Nagoya-City (JP)

(73) Assignee: NGK INSULATORS, LTD., Nagoya-City (JP)

(21) Appl. No.: 18/177,423

(22) Filed: Mar. 2, 2023

Related U.S. Application Data
(63) Continuation of application No. PCT/JP2021/029118, filed on Aug. 5, 2021.

(30) Foreign Application Priority Data
Nov. 24, 2020 (JP) 2020-194748
Dec. 2, 2020 (JP) 2020-200578

(51) Int. Cl. H01M 4/485; H01M 4/04; H01M 50/431; H01M 10/054; H01M 50/491; H01M 50/451; H01M 4/525; H01M 12/04

(52) U.S. Cl. CPC H01M 4/485; H01M 4/0404; H01M 4/525; H01M 10/054; H01M 12/04; H01M 50/431; H01M 50/451; H01M 50/491; H01M 2004/027

(57) ABSTRACT

There is provided a secondary zinc battery including: a unit cell including; a positive-electrode plate including a positive-electrode active material layer and a positive-electrode collector; a negative-electrode plate including a negative-electrode active material layer containing zinc and a negative-electrode collector; an LDH separator covering or wrapping around the entire negative-electrode active material layer; and an electrolytic solution. The positive-electrode collector has a positive-electrode collector tab extending from one edge of the positive-electrode active material layer, and the negative-electrode collector has a negative-electrode collector tab extending from the opposite edge of the negative-electrode active material layer and beyond a vertical edge of the LDH-like compound separator. The unit cell can thereby collects electricity from the positive-electrode collector tab and the negative-electrode collector tab that are disposed at opposite edges of the unit cell. The LDH-like compound separator has at least two continuous closed edges.

### CROSS-REFERENCE TO RELATED APPLICATIONS

This application is a continuation application of PCT/JP2021/029118 filed Aug. 5, 2021, which claims priority to Japanese Patent Application No. 2020-194748 filed Nov. 24, 2020 and Japanese Patent Application No. 2020-200578 filed Dec. 2, 2020, the entire contents all of which are incorporated herein by reference.

### BACKGROUND OF THE INVENTION

### 1. Field of the Invention

The present invention relates to a secondary zinc battery.

### 2. Description of the Related Art

In secondary zinc batteries, for example, secondary nickel-zinc batteries and secondary air-zinc batteries, it is known that metallic zinc dendrites precipitates on negative electrodes during a charge mode, penetrates through voids in separators, for example, non-woven fabrics and reach positive electrodes, resulting in short circuiting. Short circuiting caused by such zinc dendrites leads to a reduction in charge and discharge repetition lifetime of the secondary zinc batteries.

In order to solve such a problem, secondary zinc batteries have been proposed that include layered double hydroxide (LDH) separators selectively permitting the migration of hydroxide ions while blocking zinc dendrites. For example, Patent Literature 1 (WO2013/118561) discloses a secondary nickel-zinc battery including an LDH separator disposed between a positive electrode and a negative electrode. Patent Literature 2 (WO2016/076047) discloses a separator structure including an LDH separator that is fitted in or joined to a resin frame and has high denseness enough to inhibit permeation of gas and/or water. Patent Literature 2 also discloses that the LDH separator may be a composite with a porous substrate. Patent Literature 3 (WO2016/067884) discloses various methods of forming a dense LDH membrane on a porous substrate to give a composite material (LDH separator). The method includes the steps of: evenly depositing a starting material on a porous substrate to provide a start point of the growth of LDH crystals; and subjecting the porous substrate to a hydrothermal treatment in an aqueous stock solution for formation of the dense LDH membrane on the porous substrate.

In the meantime, Patent Literature 4 (WO2019/077953) discloses a secondary zinc battery comprising a positive-electrode plate, a negative-electrode plate, an LDH separator, and an electrolytic solution, in which the unit cell can collects electricity from a positive-electrode collector tab and a negative-electrode collector tab that are disposed at opposite edges of the unit cell.

### CITATION LIST

### Patent Literature

Patent Literature 1: WO2013/118561
Patent Literature 2: WO2016/076047
Patent Literature 3: WO2016/067884
Patent Literature 4: WO2019/077953

### SUMMARY OF THE INVENTION

A secondary zinc battery, for example, a secondary nickel-zinc battery including the LDH separator described above does not undergo short circuiting caused by zinc dendrites. In order to maximize such advantageous effects, the LDH separator should certainly separate the positive electrode from the negative electrode. In particular, it is significantly advantageous to achieve such a configuration of the separator while multiple positive and negative electrodes is readily assembled into a stacked-cell battery for generation of a high voltage and a large amount of current. Unfortunately, separation of a positive electrode from a negative electrode by an LDH separator in a traditional secondary zinc battery is achieved by a complicated and burdensome process involving joining the LDH separator to a battery container and sealing the joint by using a resin frame and/or an adhesive such that the liquid tightness is ensured. Thus, the battery configuration and the production process are likely to be complicated. Such a complicated battery configuration and process can be particularly significant in the case of a stacked-cell battery because the process involving joining the LDH separator to the battery container and sealing the joint in order to secure the liquid tightness must be carried out for each of unit cells of the stacked-cell battery.

The inventors have now found that by using an LDH-like compound described hereinafter as a hydroxide ion-conductive substance instead of conventional LDHs, it is possible to provide a hydroxide ion-conductive separator (LDH-like compound separator) having excellent alkali resistance and capable of suppressing short circuits due to zinc dendrites further effectively. The inventors have also found that by employing an LDH-like compound separator that covers or wraps around an entire negative-electrode active material layer and extending a positive-electrode collector tab and a negative-electrode collector tab in opposite directions, it is possible to omit the troublesome process involving joining the LDH-like compound separator to a battery container and sealing the joint and to provide a secondary zinc battery (particularly, a stacked-cell battery) that can block propagation of zinc dendrites and has a simple configuration that is easy to assemble and easy to collect electricity.

An object of the present invention is to provide a secondary zinc battery (particularly, a stacked-cell battery) that has excellent alkali resistance and can block propagation of zinc dendrites in a simple configuration that is easy to assemble and easy to collect electricity.

According to an aspect of the present invention, there is provided a secondary zinc battery comprising:
a unit cell comprising;
   a positive-electrode plate comprising a positive-electrode active material layer and a positive-electrode collector;
   a negative-electrode plate comprising a negative-electrode active material layer and a negative-electrode collector, the negative-electrode active material layer comprising at least one selected from the group consisting of elemental zinc, zinc oxide, zinc alloys, and zinc compounds;
   an LDH-like compound separator covering or wrapping around the entire negative-electrode active material layer; the LDH-like compound separator comprising a layered double hydroxide (LDH)-like compound, and
   an electrolytic solution,
wherein the positive-electrode active material layer, the negative-electrode active material layer, and the LDH-like compound separator each have a quadrilateral planar shape,
wherein the positive-electrode collector has a positive-electrode collector tab extending from a first edge of the positive-electrode active material layer, and the negative-electrode collector has a negative-electrode collector tab extending from a second edge of the negative-electrode active material layer and beyond a vertical edge of the LDH-like compound separator, the first edge being opposite to the second edge, the unit cell being capable of collecting electricity from the positive-electrode collector tab and the negative-electrode collector tab, the positive-electrode collector tab and the negative-electrode collector tab being disposed at opposite edges of the unit cell, and
wherein the LDH-like compound separator has at least two continuous closed edges, provided that an edge, adjacent to the negative-electrode collector tab, of the LDH-like compound separator is open.

### BRIEF DESCRIPTION OF THE DRAWINGS

FIG. 1 is a perspective view of an exemplary internal structure of a secondary zinc battery of the present invention.

FIG. 2 is a conceptual schematic cross-sectional view illustrating a layered configuration of the secondary zinc battery in FIG. 1.

FIG. 3 illustrates the appearance and the internal structure of the secondary zinc battery in FIG. 1.

FIG. 4A is a perspective view of an exemplary negative-electrode plate including a negative-electrode active material layer covered with an LDH-like compound separator of the secondary zinc battery of the present invention.

FIG. 4B is a schematic cross-sectional view illustrating a layered configuration of the negative-electrode plate in FIG. 4A.

FIG. 5 is a schematic view indicating an area of the negative-electrode plate covered with the LDH-like compound separator in FIG. 4A.

FIG. 6A is a conceptual view illustrating an example system for measuring helium permeability used in Examples A1 to A5.

FIG. 6B is a schematic cross-sectional view of a sample holder and its peripheral configuration used in the measurement system shown in FIG. 6A.

FIG. 7 is a schematic cross-sectional view illustrating an electrochemical measurement system used in Examples A1 to A5.

FIG. 8A is an SEM image of a surface of an LDH-like compound produced in Example A1.

FIG. 8B is the result of X-ray diffraction of the LDH-like compound separator produced in Example A1.

FIG. 9A is an SEM image of a surface of an LDH-like compound separator produced in Example A2.

FIG. 9B is the result of X-ray diffraction of the LDH-like compound separator produced in Example A2.

FIG. 10A is an SEM image of a surface of an LDH-like compound separator produced in Example A3.

FIG. 10B is the result of X-ray diffraction of the LDH-like compound separator produced in Example A3.

FIG. 11A is an SEM image of a surface of an LDH-like compound separator produced in Example A4.

FIG. 11B is the result of X-ray diffraction of the LDH-like compound separator produced in Example A4.

FIG. 12A is an SEM image of a surface of an LDH-like compound separator produced in Example A5.

FIG. 12B is the result of X-ray diffraction of the LDH-like compound separator produced in Example A5.

FIG. 13A is an SEM image of a surface of an LDH-like compound separator produced in Example A6.

FIG. 13B is the result of X-ray diffraction of the LDH-like compound separator produced in Example A6.

FIG. 14 is an SEM image of a surface of an LDH-like compound separator produced in Example A7.

FIG. 15A is an SEM image of a surface of an LDH separator produced in Example A8 (com parison).

FIG. 15B is the result of X-ray diffraction of the LDH separator produced in Example A8 (com parison).

FIG. 16 is an SEM image of a surface of the LDH-like compound separator produced in Example B1.

FIG. 17 is an SEM image of a surface of the LDH-like compound separator produced in Example C1.

FIG. 18 is an SEM image of a surface of the LDH-like compound separator produced in Example C2.

### DETAILED DESCRIPTION OF THE INVENTION

### Secondary Zinc Battery

A secondary zinc battery of the present invention may be of any type including zinc in a negative electrode and containing an alkali electrolytic solution (typically an aqueous alkali metal hydroxide solution). Thus, the secondary zinc battery of the invention may be a secondary nickel-zinc battery, a secondary silver oxide-zinc battery, a secondary manganese oxide-zinc battery, a secondary zinc-air battery, or any other type of secondary alkaline zinc battery. For example, the secondary zinc battery is preferably a secondary nickel-zinc battery including a positive electrode comprising nickel hydroxide and/or nickel oxyhydroxide. Alternatively, the secondary zinc battery may be a secondary zinc-air battery including a positive air electrode.

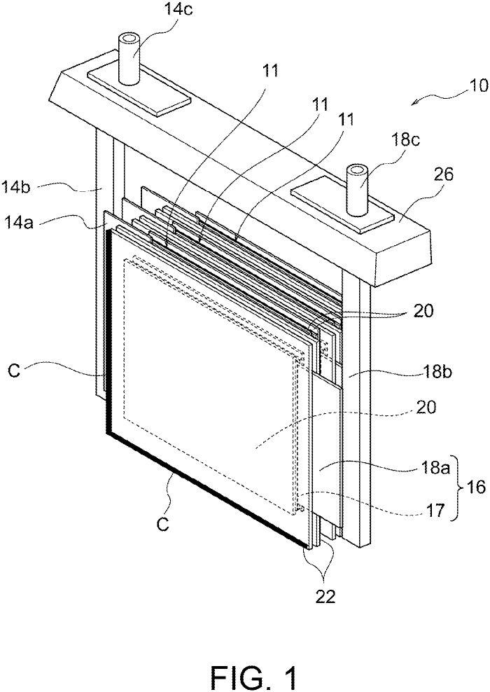

FIGS. 1 to 3 illustrate an exemplary secondary zinc battery of the present invention. A secondary zinc battery 10 illustrated in FIGS. 1 to 3 includes unit cells 11. The unit cells 11 each include a positive-electrode plate 12, a negative-electrode plate 16, a layered double hydroxide (LDH)-like compound separator 22, and an electrolytic solution (not shown). The positive-electrode plate 12 includes a positive-electrode active material layer 13 and a positive-electrode collector. The negative-electrode plate 16 includes a negative-electrode active material layer 17 and a negative-electrode collector 18. The negative-electrode active material layer 17 contains at least one selected from the group consisting of elemental zinc, zinc oxide, zinc alloys, and zinc compounds. The LDH-like compound separator 22 covers or wraps around the entire negative-electrode active material layer 17. The “LDH-like compound separator” is defined herein as a separator including an LDH-like compound and configured to selectively pass hydroxide ions exclusively by means of the hydroxide ion conductivity of the LDH-like compound. The “LDH-like compound” is defined herein as a hydroxide and/or an oxide having a layered crystal structure that cannot be called LDH but is analogous to LDH, for which no peak attributable to LDH is detected in X-ray diffraction method. The positive-electrode active material layer 13, the negative-electrode active material layer 17, and the LDH-like compound separator 22 each have a quadrilateral planar shape. The positive-electrode collector has a positive-electrode collector tab 14a extending from one edge of the positive-electrode active material layer 13. The negative-electrode collector 18 has a negative-electrode collector tab 18a extending from the opposite edge of the negative-electrode active material layer 17 and beyond a vertical or side edge of the LDH-like compound separator 22. As a result, the unit cell 11 can collect electricity from the positive-electrode collector tab 14a and the negative-electrode collector tab 18a that are disposed at opposite edges. The LDH-like compound separator 22 has at least two continuous closed edges C, with the proviso that an edge, adjacent to the negative-electrode collector tab, of the LDH-like compound separator 22 is open. By employing the LDH-like compound separator 22 that covers or wraps around the entire negative-electrode active material layer 17 and extending the positive-electrode collector tab 14a and the negative-electrode collector tab 18a in opposite directions, it is possible to omit the troublesome process involving joining the LDH-like compound separator 22 to a battery container and sealing the joint and to provide a secondary zinc battery (particularly, a stacked-cell battery) that can block propagation of zinc dendrites in a simple configuration that is easy to assemble and easy to collect electricity. Moreover, by using an LDH-like compound described hereinafter as a hydroxide ion-conductive substance instead of conventional LDHs, it is possible to provide a hydroxide ion-conductive separator (LDH-like compound separator) having excellent alkali resistance and capable of suppressing short circuits due to zinc dendrites further effectively, and also to provide a zinc secondary battery having such benefits.

As described above, separation of a positive electrode from a negative electrode by an LDH separator in a traditional secondary zinc battery is achieved by a complicated and burdensome process involving joining the LDH separator to a battery container and sealing the joint by using a resin frame and/or an adhesive such that the liquid tightness is ensured. Thus, the battery configuration and the production process are likely to be complicated. Such a complicated battery configuration and process can be particularly significant in the case of a stacked-cell battery. In the secondary zinc battery 10 of the present invention, the entire negative-electrode active material layer 17 or the negative-electrode plate 16 is covered with or wrapped by the LDH-like compound separator 22. Thus, the negative-electrode plate 16 itself covered with or wrapped by the LDH-like compound separator 22 can prevent short circuiting caused by zinc dendrites. Hence, only stacking of the positive-electrode plate 12 and the negative-electrode plate 16, which is covered with or wrapped by the LDH-like compound separator 22, can achieve separation of the positive-electrode plate 12 from the negative-electrode plate 16 by the LDH-like compound separator. Since the positive-electrode collector tab 14a and the negative-electrode collector tab 18a extend in opposite directions, unintended contact of the positive-electrode collector with the negative-electrode collector 18 can be certainly avoided and collection of electricity can be facilitated. This is significantly advantageous in that only alternate stacking of the positive-electrode plates 12 and the negative-electrode plates 16 can achieve a desired configuration, particularly, in the case of production of a stacked-cell battery including multiple unit cells: The traditional complicated and burdensome process can be omitted that involves joining an LDH separator to a battery container and sealing the joint for separation of a positive electrode from a negative electrode by the LDH separator. In the case of the stacked-cell battery, multiple positive-electrode collector tabs 14a can be bundled and connected to one positive-electrode collector plate 14b or one positive-electrode terminal 14c while multiple negative-electrode collector tabs 18a can be bundled and connected to one negative-electrode collector plate 18b or one negative-electrode terminal 18c. Collection of electricity can be thereby facilitated.

The unit cell 11 includes the positive-electrode plate 12, the negative-electrode plate 16, the LDH-like compound separator 22, and the electrolytic solution (not shown).

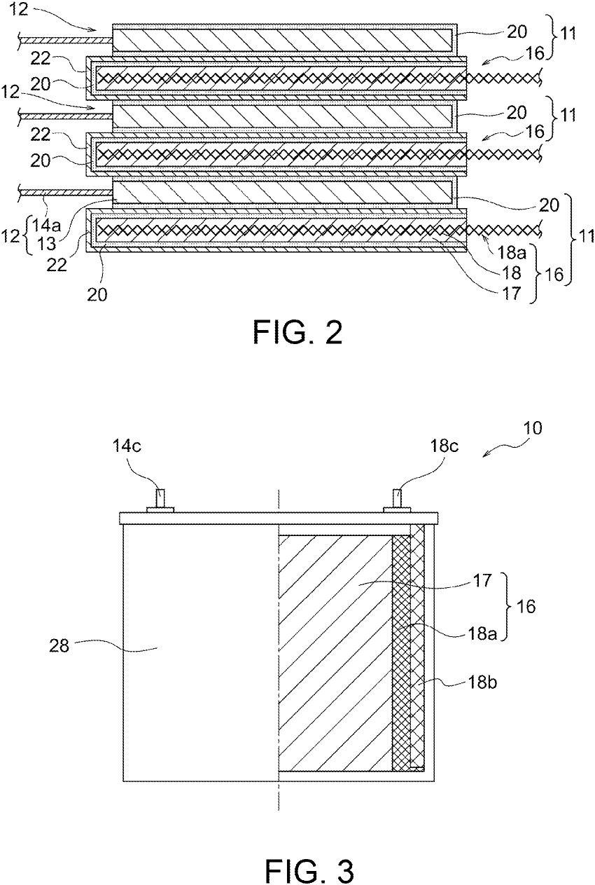

The positive-electrode plate 12 includes the positive-electrode active material layer 13. The positive-electrode active material layer 13 may be composed of any appropriately selected known material according to the type of a secondary zinc battery. For example, a positive electrode including nickel hydroxide and/or nickel oxyhydroxide may be used in a secondary nickel-zinc battery; or an air positive electrode may be used in a secondary zinc-air battery. The positive-electrode plate 12 further includes a positive-electrode collector (not shown). The positive-electrode collector has a positive-electrode collector tab 14a extending from the one edge of the positive-electrode active material layer 13. Preferred examples of the positive-electrode collector include porous nickel substrates, for example, foamed nickel plates. In this case, a porous nickel substrate is evenly coated with, for example, a paste containing an electrode active material, such as nickel hydroxide, and is then dried into a preferred platy positive electrode provided with a collector. Preferably, the dried platy positive electrode with the collector is compacted to prevent the detachment of the electrode active material and to increase the density of the electrode. Although the positive-electrode plate 12 in FIG. 2 includes a positive-electrode collector composed of, for example, foamed nickel, the positive-electrode collector is not shown. The positive-electrode collector is highly integrated with the positive-electrode active material layer 13 and thus cannot be separately illustrated. Preferably, the secondary zinc battery 10 further includes a positive-electrode collector plate 14b, which is connected to an end of the positive-electrode collector tab 14a. One positive-electrode collector plate 14b is more preferably connected to ends of multiple positive-electrode collector tabs 14a. Such a simple configuration facilitates collection of electricity while the space can be efficiently used. The connection of the positive-electrode collector plate 14b to the positive-electrode terminal 14c is also facilitated. The positive-electrode collector plate 14b itself may serve as a positive-electrode terminal.

The negative-electrode plate 16 includes a negative-electrode active material layer 17. The negative-electrode active material layer 17 contains at least one selected from the group consisting of elemental zinc, zinc oxide, zinc alloys, and zinc compounds. In other words, any form of zinc, for example, elemental zinc, zinc compound, or zinc alloy, that has an electrochemical activity suitable for a negative electrode may be used. Preferred examples of the material for the negative electrode include zinc oxide, elemental zinc, and calcium zincate. A mixture of elemental zinc and zinc oxide is more preferred. The negative-electrode active material layer 17 may be gelled. The negative-electrode active material layer 16 may be composed of a mixture of a negative-electrode active material and an electrolytic solution. For example, addition of an electrolytic solution and a thickener to the negative-electrode active material can readily produce a gelled negative electrode. Examples of the thickener include poly(vinyl alcohol), polyacrylate, carboxymethyl cellulose (CMC), and alginic acid. Poly(acrylic acid) is preferred because it has significant chemical resistance against strong alkalis.

A mercury-free zinc alloy or a lead-free zinc alloy may also be used. For example, a zinc alloy should preferably contain 0.01 to 0.1 mass% indium, 0.005 to 0.02 mass% bismuth, and 0.0035 to 0.015 mass% aluminum to inhibit emission of gaseous hydrogen. In particular, indium and bismuth are advantageous from the viewpoint of an improvement in discharge performance. Use of a zinc alloy in the negative electrode can reduce self-dissolution of the negative electrode in an alkaline electrolytic solution, resulting in reduced emission of gaseous hydrogen and thus enhanced safety.

The material for the negative electrode may have any form but preferably a powder form. The negative electrode thereby has a large surface area and can discharge a large current. A material, composed of a zinc alloy, for the negative electrode preferably has a mean particle size ranging from 3 to 100 µm in minor axis. A negative electrode composed of zinc alloy particles with a mean particle size in such a range has a large surface area and is thus suitable for discharge of a large amount of current. Such a material can be homogeneously mixed with an electrolytic solution and a gelling agent and readily handled during assembly of a battery.

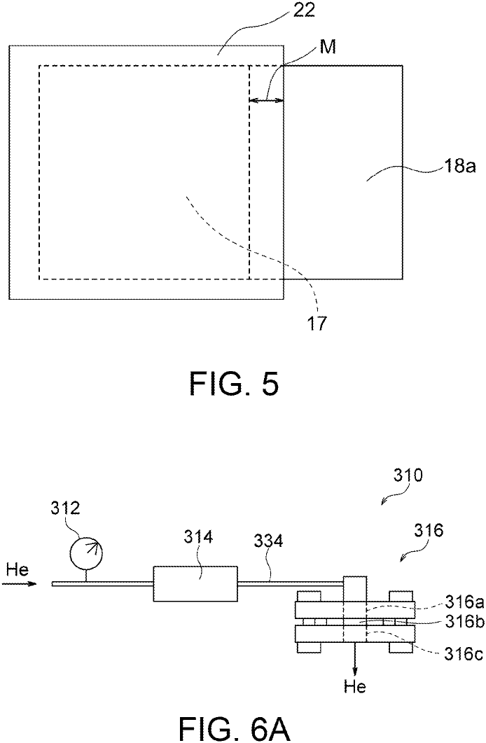

The negative-electrode plate 16 includes the negative-electrode collector 18. The negative-electrode collector 18 has the negative-electrode collector tab 18a extending from one edge, remote from the positive-electrode collector tab 14a, of the negative-electrode active material layer 17 and beyond the vertical edge of the LDH-like compound separator 22. As a result, the unit cell 11 can collect electricity from the positive-electrode collector tab 14a and the negative-electrode collector tab 18a that are disposed at opposite edges. Preferably, the secondary zinc battery 10 includes the negative-electrode collector plate 18b, which is connected to an end of the negative-electrode collector tab 18a. One negative-electrode collector plate 18b is more preferably connected to ends of multiple negative-electrode collector tabs 18a. Such a simple configuration facilitates collection of electricity while the space can be efficiently used. The connection of the negative-electrode collector tab 18a to the negative-electrode terminal 18c is also facilitated. The negative-electrode collector plate 18b itself may serve as a negative-electrode terminal. Typically, one edge of the negative-electrode collector tab 18a should be preferably exposed from the LDH-like compound separator 22 and a liquid retention material 20 (if present). The exposed edge of the negative-electrode collector tab 18a enables desired connection of the negative-electrode collector 18 to the negative-electrode collector plate 18b and/or the negative-electrode terminal 18c. In this case, a vertical edge, adjacent to the negative-electrode collector tab 18a, of the negative-electrode active material layer 17 should preferably be covered with or wrapped by the LDH-like compound separator 22 with a margin M (for example, with a distance of 1 to 5 mm) such that the LDH-like compound separator 22 sufficiently hides the vertical edge, as illustrated in FIG. 5. This can more effectively block the propagation of the zinc dendrites from the vertical edge, adjacent to the negative-electrode collector tab 18a, of the negative-electrode active material layer 17 or from the neighborhood of the vertical edge.

Preferred examples of the negative-electrode collector 18 includes copper foils, expanded copper metals, and punched copper metals. Expanded copper metals are more preferred. For example, an expanded copper metal is coated with a mixture of powdered zinc oxide and/or elemental zinc and a binder (for example, particulate polytetrafluoroethylene) as desired. A preferred platy negative electrode provided with a collector can be thereby produced. Preferably, the dried platy negative electrode with the collector is compacted to prevent the detachment of the electrode active material and to increase the density of the electrode.

It is preferred that the secondary zinc battery 10 further includes a liquid retention material 20 disposed between the negative-electrode active material layer 17 and the LDH-like compound separator 22 and cover or wrap around the entire negative-electrode active material layer 17. An electrolytic solution can be uniformly distributed between the negative-electrode active material layer 17 and the LDH-like compound separator 22, resulting in effective migration of hydroxide ions between the negative-electrode active material layer 17 and the LDH-like compound separator 22. The liquid retention material 20 may be of any type that can hold an electrolytic solution. The liquid retention material 20 should preferably be sheeted. Preferred examples of the liquid retention material include non-woven fabrics, water-absorbing resins, liquid retaining resins, porous sheets, and spacers. The non-woven fabrics are particularly preferred because a low-cost high-performance negative-electrode structure can be produced. The liquid retention material 20 preferably has a thickness of 0.01 to 0.20 mm, more preferably 0.02 to 0.20 mm, further preferably 0.02 to 0.15 mm, particularly preferably 0.02 to 0.10 mm, most preferably 0.02 to 0.06 mm. The liquid retention material 20 having a thickness in such a range can minimize the size of the overall negative-electrode structure while holding a sufficient volume of electrolytic solution.

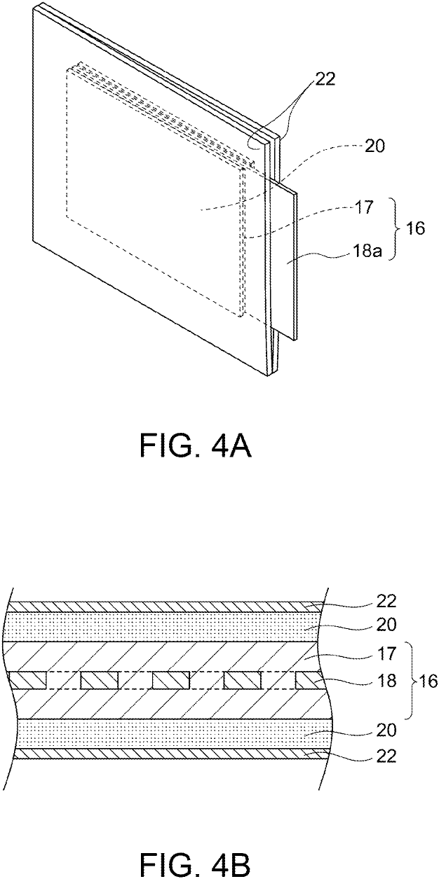

The entire negative-electrode active material layer 17 is covered with or wrapped by the LDH-like compound separator 22. FIGS. 4A and 4B illustrate a preferred embodiment of the negative-electrode plate 16 including the negative-electrode active material layer 17 covered with or wrapped by the LDH-like compound separator 22. The negative-electrode structure in FIGS. 4A and 4B includes the negative-electrode active material layer 17, the negative-electrode collector 18, and optionally the liquid retention material 20. The entire negative-electrode active material layer 17 is covered with or wrapped by the LDH-like compound separator 22 (optionally, with the intervention of the liquid retention material 20). As described above, the entire negative-electrode active material layer 17 covered with or wrapped by the LDH-like compound separator 22 (optionally, with the intervention of the liquid retention material 20) can omit a troublesome process involving joining the LDH-like compound separator 22 to a battery container and sealing the joint. A secondary zinc battery (particularly, a stacked-cell battery) that can block the propagation of the zinc dendrites can be thereby produced in a significantly simple and highly productive way.

In FIGS. 4A and 4B, the liquid retention material 20 is depicted to be smaller than the LDH-like compound separator 22. Alternatively, the liquid retention material 20 may have the same dimensions as the LDH-like compound separator 22 (or a folded LDH-like compound separator 22) such that the edges of the liquid retention material 20 and the edges of the LDH-like compound separator 22 reside at the same position. In other words, the liquid retention material 20 may be held between two folded or two bonded segments of the LDH-like compound separator 22. This structure enables effective sealing of an edge of the LDH-like compound separator 22 by thermal or ultrasonic welding, which will be described below. In other words, the edges of the LDH-like compound separator 22 can be more effectively sealed by indirect thermal or ultrasonic welding by the intervention of the thermally weldable liquid retention material 20 than direct thermal or ultrasonic welding, resulting in more effective sealing due to the thermal weldability of the liquid retention material 20. In consequence, the edges, to be sealed with that of the LDH-like compound separator 22, of the liquid retention material 20 can serve as a hot-melt adhesive. Preferred examples of the liquid retention material 20 in this case include non-woven fabrics, particularly non-woven fabrics composed of thermoplastic resin (for example, polyethylene or polypropylene).

The LDH-like compound separator 22 includes an LDH-like compound and a porous substrate. The pores of the substrate are filled with the LDH-like compound, so that the LDH-like compound separator 22 has hydroxide-ion conductivity and gas-impermeability (and thus permits migration of hydroxide ions). The porous substrate is preferably composed of a polymeric material. The LDH-like compound is particularly preferably incorporated into the polymeric porous substrate over the entire thickness thereof. Various preferred embodiments of the LDH-like compound separator 22 will be detailed below.

In a typical embodiment, one LDH-like compound separator 22 is provided on one side of the negative-electrode active material layer 17. In detail, one LDH-like compound separator 22 is folded onto the two sides of the negative-electrode active material layer 17. Alternatively, two separator segments of the LDH-like compound separator 22 are respectively provided on the two sides of the negative-electrode active material layer 17. Alternatively, two or more plies of LDH-like compound separators 22 may be provided on the two sides of the negative-electrode active material layer 17. For example, several plies of LDH-like compound separators 22 may cover or wrap around the entire negative-electrode active material layer 17 (that may be covered with or wrapped by the liquid retention material 20).

As describe above, the LDH-like compound separator 22 has a quadrilateral planar shape. The LDH-like compound separator 22 or the separator segments of the LDH-like compound separator 22 have at least two continuous closed edges C, with the proviso that the edge, adjacent to the negative-electrode collector tab 18a, of the LDH-like compound separator 22 is open. Such an LDH-like compound separator 22 can certainly separate the negative-electrode active material layer 17 from the positive-electrode plate 12 and more effectively block the propagation of zinc dendrites. The edges C to be sealed do not include one edge, adjacent to the negative-electrode collector tab 18a, of the LDH-like compound separator 22 such that negative-electrode collector tab 18a can extend to the exterior.

In a preferred embodiment of the present invention, the unit cell 11 is disposed such that the positive-electrode plate 12, the negative-electrode plate 16, and the LDH-like compound separator 22 are vertically disposed and such that one closed edge of the LDH-like compound separator 22 resides on the bottom. As a result, the positive-electrode collector tab 14a and the negative-electrode collector tab 18a extend laterally from opposite edges of the unit cell 11. This further facilitates collection of electricity. In the case that the upper edge of the LDH-like compound separator 22 is open as will be described below, the upper edge of the LDH-like compound separator 22 is not blocked. Thus, the migration of gas between the positive-electrode plate 12 and the negative-electrode plate 16 can be further facilitated.

The LDH-like compound separator 22 may be open on one or two edges. Even if, for example, the upper edge of the LDH-like compound separator 22 is open, an electrolytic solution can be injected so as not to reach the upper edge of the LDH-like compound separator during production of the secondary zinc battery. Since the electrolytic solution is below the upper edge of the LDH-like compound separator, the leakage of the solution and the propagation of zinc dendrites can be avoided. In this regard, the unit cell 11 as well as the positive-electrode plate 12 are accommodated into a closed container or a case 28 and covered with a lid 26 as desired. The unit cell 11 can serve as a main component of a sealed type of secondary zinc battery. The case 28 eventually ensure the air-tightness of the unit cell 11; hence, the unit cell 11 itself may have a simple configuration with an open upper edge. Since the LDH-like compound separator 22 is open on one edge, the negative-electrode collector tab 18a can extend therefrom.

The upper edge of the LDH-like compound separator 22 is preferably open. This configuration with the open upper edge can solve a problem caused by overcharge of, for example, a nickel-zinc battery. If the nickel-zinc battery is overcharged, oxygen (O₂) may be generated at the positive-electrode plate 12. The LDH-like compound separator 22 has high denseness that substantially permit migration of only hydroxide ions, but not migration of O₂. The configuration with the open upper edge enables O₂ to escape from the open upper edge of the positive-electrode plate 12 to the negative-electrode plate 16, in the case 28. O₂ then reacts with Zn in the negative-electrode active material layer 17 into ZnO. The unit cell 11 of open top type, which permits such reaction cycles of oxygen, can be used in a sealed type of secondary zinc battery to enhance durability to overcharge. It should be noted that an LDH-like compound separator 22 with a closed upper edge can also achieve the same effects as the LDH-like compound separator 22 with the open upper edge if a vent is disposed at any position of the closed upper edge. For example, the vent may be formed after sealing of the upper edge of the LDH-like compound separator 22. Alternatively, part of the upper edge may be left unsealed during sealing of the LDH-like compound separator 22 for formation of a vent.

In any case, it is preferred to close the edges C of the LDH-like compound separator 22 by folding it and/or sealing the separator segments of the LDH-like compound separator 22. Preferred examples of sealing techniques include adhesives, thermal welding, ultrasonic welding, adhesion tapes, sealing tapes, and combination thereof. In particular, the LDH-like compound separator 22 including a porous substrate composed of a polymeric material is advantageous in that it is flexible and thus readily foldable. Hence, it is preferred to form an elongated LDH-like compound separator 22 and then fold the LDH-like compound separator 22 such that one edge of the LDH-like compound separator 22 is automatically closed. Thermal or ultrasonic welding may be carried out with a commercially available heat sealer. For sealing of the LDH-like compound separator 22, it is preferred to hold the liquid retention material 20 between two folded or two bonded segments of the LDH-like compound separator 22 and to carry out thermal or ultrasonic welding because more effective sealing can be achieved. A commercially available adhesive, adhesion tape, or sealing tape may be used that preferably contains resin having high alkaline resistance in order to prevent degradation in an alkaline electrolytic solution. Examples of adhesives preferred from this point of view include epoxy resin adhesives, natural resin adhesives, modified olefin resin adhesives, and modified silicone resin adhesives. Among them, epoxy resin adhesives are particularly preferred because they have significantly high alkaline resistance. An exemplary commercial product of an epoxy resin adhesive is Hysol® (available from Henkel).

The electrolytic solution preferably contains an aqueous alkali metal hydroxide solution. Although not illustrated, the positive electrode plate 12 (particularly, the positive-electrode active material layer 13) and the negative-electrode plate 16 (particularly, the negative-electrode active material layer 17) are entirely immersed in the electrolytic solution. Examples of alkali metal hydroxide include potassium hydroxide, sodium hydroxide, lithium hydroxide, and ammonium hydroxide. Potassium hydroxide is more preferred. In order to inhibit self-dissolution of zinc and/or zinc oxide, a zinc compound, for example, zinc oxide or zinc hydroxide may be added to the electrolytic solution. As described above, the electrolytic solution may be mixed with a positive-electrode active material or a negative-electrode active material to yield a mixture of the electrolytic solution and the positive-electrode active material or a mixture of the electrolytic solution and the negative-electrode active material. In order to prevent leakage of the electrolytic solution, the electrolytic solution may be gelled. A polymeric gelling agent is preferably used that absorbs the solvent in the electrolytic solution to swell. For example, a polymer such as polyethylene oxide, poly(vinyl alcohol), or polyacrylamide, or starch is used.

As illustrated in FIG. 3, the secondary zinc battery 10 may further include at least one case 28 that accommodates the unit cell 11. Two or more unit cells 11 may be accommodated in the respective cases 28. This is a configuration of a so-called stacked-cell battery and is advantageous in that a high voltage and a large amount of current can be generated. The case 28 accommodating the unit cells 11 is preferably composed of resin. The resin contained in the case 28 preferably has resistance against alkali metal hydroxide, for example, potassium hydroxide and is more preferably polyolefin, acrylonitrile butadiene styrene (ABS), or modified polyphenylene ether, further preferably ABS or modified polyphenylene ether. A group of two or more arrayed cases 28 may be accommodated in an outer frame to serve as a battery module.

### LDH-Like Compound Separator

The LDH-like compound separator includes a layered double hydroxide (LDH)-like compound, and can isolate a positive electrode plate from a negative electrode plate and ensures hydroxide ionic conductivity therebetween in a secondary zinc battery. The LDH-like compound separator functions as a hydroxide ionic conductive separator. Preferred LDH-like compound separator has gas-impermeability and/or water-impermeability. In other words, the LDH-like compound separator is preferably densified to an extent that exhibits gas-impermeability and/or water-impermeability. The phrase “having gas-impermeability” throughout the specification indicates that no bubbling of helium gas is observed at one side of a sample when helium gas is brought into contact with the other side in water at a differential pressure of 0.5 atm as described in Patent Literatures 2 and 3. In addition, the phrase “having water-impermeability” throughout the specification indicates that water in contact with one side of the sample does not permeate to the other side as described in Patent Literatures 2 and 3. As a result, the LDH-like compound separator having gas-impermeability and/or water-impermeability indicates having high density to an extent that no gas or no water permeates, and not being a porous membrane or any other porous material that has gas-permeability or water-permeability. Accordingly, the LDH-like compound separator can selectively permeate only hydroxide ions due to its hydroxide ionic conductivity, and can serve as a battery separator. The LDH-like compound separator thereby has a physical configuration that prevents penetration of zinc dendrites generated during a charge mode through the separator, resulting in prevention of short circuit between positive and negative electrodes. Since the LDH-like compound separator has hydroxide ionic conductivity, the ionic conductivity allows a necessary amount of hydroxide ions to efficiently move between the positive electrode plate and the negative electrode plate, and thereby charge/discharge reaction can be achieved on the positive electrode plate and the negative electrode plate.

The LDH-like compound separator preferably has a helium permeability per unit area of 3.0 cm/min·atm or less, more preferably 2.0 cm/min·atm or less, further more preferably 1.0 cm/min·atm or less. A separator having a helium permeability of 3.0 cm/min·atm or less can remarkably restrain the permeation of Zn (typically, the permeation of zinc ions or zincate ions) in the electrolytic solution. Thus, it is conceivable in principle that the separator of the present embodiment can effectively restrain the growth of zinc dendrites when used in secondary zinc batteries because Zn permeation is significantly suppressed. The helium permeability is measured through the steps of: supplying helium gas to one side of the separator to allow the helium gas to permeate into the separator; and calculating the helium permeability to evaluate the density of the hydroxide ion conductive separator. The helium permeability is calculated from the expression of F/(P×S) where F is the volume of permeated helium gas per unit time, P is the differential pressure applied to the separator when helium gas permeates through, and S is the area of the membrane through which helium gas permeates. Evaluation of the permeability of helium gas in this manner can extremely precisely determine the density. As a result, a high degree of density that does not permeate as much as possible (or permeate only a trace amount) substances other than hydroxide ions (in particular, zinc that causes deposition of dendritic zinc) can be effectively evaluated. Helium gas is suitable for this evaluation because the helium gas has the smallest constitutional unit among various atoms or molecules which can constitute the gas and its reactivity is extremely low. That is, helium does not form a molecule, and helium gas is present in the atomic form. In this respect, since hydrogen gas is present in the molecular form (H₂), atomic helium is smaller than molecular H₂ in a gaseous state. Basically, H₂ gas is combustible and dangerous. By using the helium gas permeability defined by the above expression as an index, the density can be precisely and readily evaluated regardless of differences in sample size and measurement condition. Thus, whether the separator has sufficiently high density suitable for separators of secondary zinc batteries can be evaluated readily, safely and effectively. The helium permeability can be preferably measured in accordance with the procedure shown in Evaluation 5 in Examples described later.

In the LDH-like compound separator of the present invention, the pores in the porous substrate are filled with the LDH-like compound, preferably completely filled with the LDH-like compound. Preferably, the LDH-like compound is:
(a) a hydroxide and/or an oxide with a layered crystal structure, containing: Mg; and one or more elements, which include at least Ti, selected from the group consisting of Ti, Y, and Al, or
(b) a hydroxide and/or an oxide with a layered crystal structure, comprising (i) Ti, Y, and optionally Al and/or Mg, and (ii) at least one additive element M selected from the group consisting of In, Bi, Ca, Sr, and Ba, or
(c) a hydroxide and/or an oxide with a layered crystal structure, comprising Mg, Ti, Y, and optionally Al and/or In, wherein in (c) the LDH-like compound is present in a form of a mixture with In(OH)₃.

According to a preferred embodiment (a) of the present invention, the LDH-like compound is a hydroxide and/or an oxide with a layered crystal structure containing: Mg; and one or more elements, which include at least Ti, selected from the group consisting of Ti, Y, and Al. Accordingly, the LDH-like compound is typically a composite hydroxide and/or a composite oxide of Mg, Ti, optionally Y, and optionally Al. The aforementioned elements may be replaced with other elements or ions to the extent that the basic properties of the LDH-like compound are not impaired, but the LDH-like compound is preferably free from Ni. For example, the LDH-like compound may further contain Zn and/or K. This can further improve the ion conductivity of the LDH-like compound separator.

The LDH-like compound can be identified by X-ray diffraction. Specifically, the LDH-like compound separator has a peak that is derived from the LDH-like compound and detected in the range of typically 5° ≤ 2θ ≤ 10°, more typically 7° ≤ 2θ ≤ 10°, when X-ray diffraction is performed on its surface. As described above, an LDH is a substance having an alternating laminated structure in which exchangeable anions and H₂O are present as an interlayer between stacked basic hydroxide layers. In this regard, when the LDH is measured by X-ray diffraction, a peak due to the crystal structure of the LDH (that is, the (003) peak of LDH) is originally detected at a position of 2θ = 11° to 12°. In contrast, when the LDH-like compound is measured by X-ray diffraction, a peak is typically detected in such a range shifted toward the low angle side from the peak position of the LDH. Further, the interlayer distance in the layered crystal structure can be determined by Bragg’s equation using 2θ corresponding to peaks derived from the LDH-like compound in X-ray diffraction. The interlayer distance in the layered crystal structure constituting the LDH-like compound thus determined is typically 0.883 to 1.8 nm, more typically 0.883 to 1.3 nm.

The LDH-like compound separator according to the above embodiment (a) preferably has an atomic ratio Mg/(Mg + Ti + Y + Al) in the LDH-like compound, as determined by energy dispersive X-ray spectroscopy (EDS), of 0.03 to 0.25, more preferably 0.05 to 0.2. Further, an atomic ratio Ti/(Mg + Ti + Y + Al) in the LDH-like compound is preferably 0.40 to 0.97, more preferably 0.47 to 0.94. Further, an atomic ratio Y/(Mg + Ti + Y + Al) in the LDH-like compound is preferably 0 to 0.45, more preferably 0 to 0.37. Further, an atomic ratio Al/(Mg + Ti + Y + Al) in the LDH-like compound is preferably 0 to 0.05, more preferably 0 to 0.03. Within such a range, the alkali resistance is further excellent, and the effect of suppressing short circuits due to zinc dendrites (that is, dendrite resistance) can be achieved more effectively. Meanwhile, LDHs conventionally known for LDH separators can be expressed by a basic composition represented by the formula: M²⁺₁₋ ₓM³⁺ₓ (OH)₂Aⁿ⁻_{x/}n·mH₂O (in the formula, M²⁺ is a divalent cation, M³⁺ is a trivalent cation, Aⁿ⁻ is an n-valent anion, n is an integer of 1 or more, x is 0.1 to 0.4, and m is 0 or more). In contrast, the aforementioned atomic ratios in the LDH-like compound generally deviate from those in the aforementioned formula of LDH. Therefore, it can be said that the LDH-like compound in the present embodiment generally has composition ratios (atomic ratios) different from those of such a conventional LDH. The EDS analysis is preferably performed by 1) capturing an image at an acceleration voltage of 20 kV and a magnification of 5,000 times, 2) performing analysis at three points at intervals of about 5 µm in the point analysis mode, 3) repeating procedures 1) and 2) above once again, and 4) calculating an average of the six points in total, using an EDS analyzer (for example, X-act, manufactured by Oxford Instruments).

According to another embodiment (b), the LDH-like compound may be a hydroxide and/or an oxide with a layered crystal structure containing (i) Ti, Y, and optionally Al and/or Mg, and (ii) an additive element M. Therefore, the LDH-like compound is typically a complex hydroxide and/or a complex oxide with Ti, Y, the additive element M, and optionally Al and optionally Mg. The additive element M is In, Bi, Ca, Sr, Ba, or combinations thereof. The elements described above may be replaced by other elements or ions to the extent that the basic properties of the LDH-like compound are not impaired, and the LDH-like compound is preferably free of Ni.

The LDH-like compound separator according to the above embodiment (b) preferably has an atomic ratio of Ti/(Mg + Al + Ti + Y + M) of 0.50 to 0.85 in the LDH-like compound, as determined by energy dispersive X-ray spectroscopy (EDS) and more preferably has the atomic ratio of 0.56 to 0.81. An atomic ratio of Y/(Mg + Al + Ti + Y + M) in the LDH-like compound is preferably 0.03 to 0.20 and more preferably 0.07 to 0.15. An atomic ratio of M/(Mg + Al + Ti + Y + M) in the LDH-like compound is preferably 0.03 to 0.35 and more preferably 0.03 and 0.32. An atomic ratio of Mg/(Mg + Al + Ti + Y + M) in the LDH-like compound is preferably 0 to 0.10 and more preferably 0 to 0.02. In addition, an atomic ratio of AI/(Mg + Al + Ti + Y + M) in the LDH-like compound is preferably 0 to 0.05 and more preferably 0 to 0.04. The ratios within the above ranges enable to achieve more excellent alkali resistance and a short-circuit inhibition effect caused by zinc dendrite (i.e., dendrite resistance) in more efficient manner. By the way, an LDH that is conventionally known with respect to an LDH separator, can be represented by the basic composition of the formula: M²⁺₁₋ₓM³⁺ₓ(OH)₂Aⁿ⁻_{x/n}·mH₂O wherein M²⁺ is a divalent cation, M³⁺ is a trivalent cation, Aⁿ⁻ is an n-valent anion, n is an integer of 1 or greater, x is 0.1 to 0.4, and m is an integer of to 0 or greater. In contrast, the above atomic ratio in the LDH-like compound generally deviates from that of the above formula of LDH. Therefore, the LDH-like compound in the present embodiment can be generally said to have a composition ratio (atomic ratio) different from that of conventional LDH. The EDS analysis is preferably carried out with an EDS analyzer (for example, X-act manufactured by Oxford Instruments) by 1) capturing an image at an accelerating voltage of 20 kV and a magnification of 5,000 times, 2) carrying out a three-point analysis at about 5 µm intervals in a point analysis mode, 3) repeating the above 1) and 2) once more, and 4) calculating an average value of a total of 6 points.

According to yet another embodiment (c), the LDH-like compound may be a hydroxide and/or an oxide with a layered crystal structure, comprising Mg, Ti, Y, and optionally Al and/or In, in which the LDH-like compound is present in a form of a mixture with In(OH)₃. The LDH-like compound of the present embodiment is a hydroxide and/or an oxide with a layered crystal structure containing Mg, Ti, Y, and optionally Al and/or In. Therefore, the typical LDH-like compound is a complex hydroxide and/or a complex oxide with Mg, Ti, Y, optionally Al, and optionally In. Here, In that can be contained in the LDH-like compound may be not only one intentionally added, but also one unavoidably incorporated in the LDH-like compound derived from formation of In(OH)₃ or the like. The elements described above may be replaced by other elements or ions to the extent that the basic properties of the LDH-like compound are not impaired, and the LDH-like compound is preferably free of Ni. By the way, an LDH that is conventionally known with respect to an LDH separator, can be represented by the basic composition of the formula: M²⁺₁₋ₓM³⁺ₓ(OH)₂Aⁿ⁻_{x/n}·mH₂O wherein M²⁺ is a divalent cation, M³⁺ is a trivalent cation, Aⁿ⁻ is an n-valent anion, n is an integer of 1 or greater, x is 0.1 to 0.4, and m is 0 or greater. In contrast, the atomic ratio in the LDH-like compound generally deviates from that of the above formula of LDH. Therefore, the LDH-like compound in the present embodiment can be generally said to have a composition ratio (atomic ratio) different from that of conventional LDH.

The mixture according to the above embodiment (c) contains not only the LDH-like compound but also In(OH)₃ (typically composed of the LDH-like compound and In(OH)₃). In(OH)₃ contained effectively improves alkali resistance and dendrite resistance in the LDH-like compound separator. The content ratio of In(OH)₃ in the mixture is preferably an amount that can improve the alkali resistance and dendrite resistance without impairing hydroxide-ion conductivity of the LDH-like compound separator and is not limited to any particular amount. In(OH)₃ may have a cubic crystal structure and may be in a configuration where the crystals thereof are surrounded by the LDH-like compounds. The In(OH)₃ can be identified by X-ray diffraction; and X-ray diffraction measurement is preferably conducted according to the procedure described in the Example below.

As described above, the LDH-like compound separator comprises the LDH-like compound and the porous substrate (typically consists of the porous substrate and the LDH-like compound), and the LDH-like compound plugs the pores in the porous substrate such that the LDH-like compound separator exhibits hydroxide ionic conductivity and gas-impermeability (thus, so as to serve as an LDH-like compound separator exhibiting hydroxide ionic conductivity). In particular, the LDH-like compound is preferably incorporated into the porous substrate composed of a polymeric material over the entire thickness of the porous substrate. The LDH-like compound separator has a thickness of preferably 5 to 80 µm, more preferably 5 to 60 µm, further more preferably 5 to 40 µm.

The porous substrate is composed of a polymeric material. The polymeric porous substrate has the following advantages; (1) high flexibility (hard to crack even if thinned), (2) high porosity, (3) high conductivity (small thickness with high porosity), and (4) good manufacturability and handling ability. The polymeric porous substrate has a further advantage; (5) readily folding and sealing the LDH-like compound separator including the porous substrate composed of the polymeric material based on the advantage (1): high flexibility. Preferred examples of the polymeric material include polystyrene, poly(ether sulfone), polypropylene, epoxy resin, poly(phenylene sulfide), fluorocarbon resin (tetra-fluorinated resin such as PTFE), cellulose, nylon, polyethylene and any combination thereof. More preferred examples include polystyrene, poly(ether sulfone), polypropylene, epoxy resin, poly(phenylene sulfide), fluorocarbon resin (tetra-fluorinated resin such as PTFE), nylon, polyethylene and any combination thereof from the viewpoint of a thermoplastic resin suitable for hot pressing. All the various preferred materials described above have alkali resistance to be resistant to the electrolytic solution of batteries. More preferred polymeric materials are polyolefins, such as polypropylene and polyethylene, most preferred are polypropylene and polyethylene from the viewpoint of excellent hot-water resistance, acid resistance and alkali resistance, and low material cost. In case that the porous substrate is composed of the polymeric material, the LDH-like compound layer is particularly preferably embedded over the entire thickness of the porous substrate (for example, most pores or substantially all pores inside the porous substrate are filled with the LDH-like compound). A polymeric microporous membrane commercially available can be preferably used as such a polymeric porous substrate.

### Production Method

The method for producing the LDH-like compound separator is not specifically limited, and the LDH-like compound separator can be produced by appropriately changing various conditions (particularly, the composition of LDH raw materials) in the already known methods (for example, see Patent Literatures 1 to 4) for producing an LDH-containing function layer and a composite material. For example, an LDH-like compound-containing function layer and a composite material (that is, an LDH-like compound separator) can be produced by (1) preparing a porous substrate, (2) applying a solution containing titania sol (or further containing yttrium sol and/or alum ina sol) to the porous substrate, followed by drying, to form a titania-containing layer, (3) immersing the porous substrate in a raw material aqueous solution containing magnesium ions (Mg²⁺) and urea (or further containing yttrium ions (Y³⁺)), and (4) hydrothermally treating the porous substrate in the raw material aqueous solution, to form an LDH-like compound-containing function layer on the porous substrate and/or in the porous substrate. It is considered that the presence of urea in step (3) above generates ammonia in the solution through hydrolysis of urea, to increase the pH value, and coexisting metal ions form a hydroxide and/or an oxide, so that the LDH-like compound can be obtained.

In particular, in the case of producing a composite material (that is, an LDH-like compound separator) in which the porous substrate is composed of a polymer material, and the LDH-like compound is incorporated over the entire thickness direction of the porous substrate, the mixed sol solution is preferably applied to the substrate in step (2) above by a technique that allows the mixed sol solution to penetrate all or most of the inside of the substrate. This allows most or almost all the pores inside the porous substrate to be finally filled with the LDH-like compound. Preferable examples of the application technique include dip coating and filtration coating, particularly preferably dip coating. Adjusting the number of applications such as dip coating enables adjustment of the amount of the mixed sol solution to be applied. The substrate coated with the mixed sol solution by dip coating or the like may be dried and then subjected to steps (3) and (4) above.

When the porous substrate is composed of a polymer material, an LDH-like compound separator obtained by the aforementioned method or the like is preferably pressed. This enables an LDH-like compound separator with further excellent denseness to be obtained. The pressing technique is not specifically limited and may be, for example, roll pressing, uniaxial compression press, CIP (cold isotropic pressing) or the like but is preferably roll pressing. This pressing is preferably performed under heating, since the porous polymer substrate is softened, so that the pores of the porous substrate can be sufficiently filled with the LDH-like compound. For sufficient softening, the heating temperature is preferably 60 to 200° C., for example, in the case of polypropylene or polyethylene. The pressing such as roll pressing within such a temperature range can considerably reduce residual pores in the LDH-like compound separator. As a result, the LDH-like compound separator can be extremely densified, and short circuits due to zinc dendrites can be thus suppressed further effectively. Appropriately adjusting the roll gap and the roll temperature in roll pressing enables the morphology of residual pores to be controlled, thereby enabling an LDH-like compound separator with desired denseness to be obtained.

### EXAMPLES

LDH-like compound separators usable in the present invention will now be described more specifically by way of the following Examples.

### Examples A1 to A8

Examples A1 to A7 shown below are reference examples for LDH-like compound separators, while Example A8 shown below is a comparative example for an LDH separator. The LDH-like compound separators and LDH separator will be collectively referred to as hydroxide ion-conductive separators. The method for evaluating the hydroxide ion-conductive separators produced in the following examples was as follows.

### Evaluation 1: Observation of Surface Microstructure

The surface microstructure of the hydroxide ion-conductive separator was observed using a scanning electron microscope (SEM, JSM-6610LV, manufactured by JEOL Ltd.) at an acceleration voltage of 10 to 20 kV.

### Evaluation 2: STEM Analysis of Layered Structure

The layered structure of the hydroxide ion-conductive separator was observed using a scanning transmission electron microscope (STEM) (product name: JEM-ARM200F, manufactured by JEOL Ltd.) at an acceleration voltage of 200 kV.

### Evaluation 3: Elemental Analysis Evaluation (EDS)

A surface of the hydroxide ion-conductive separator was subjected to compositional analysis using an EDS analyzer (device name: X-act, manufactured by Oxford Instruments), to calculate the composition ratio (atomic ratio) Mg:Ti:Y:Al. This analysis was performed by 1) capturing an image at an acceleration voltage of 20 kV and a magnification of 5,000 times, 2) performing analysis at three points at intervals of about 5 µm in the point analysis mode, 3) repeating procedures 1) and 2) above once again, and 4) calculating an average of the six points in total.

### Evaluation 4: X-Ray Diffraction Measurement

Using an X-ray diffractometer (RINT TTR III, manufactured by Rigaku Corporation), the crystalline phase of the hydroxide ion-conductive separator was measured under the measurement conditions of voltage: 50 kV, current value: 300 mA, and measurement range: 5 to 40°, to obtain an XRD profile. Further, the interlayer distance in the layered crystal structure was determined by Bragg’s equation using 2θ corresponding to peaks derived from the LDH-like compound.

### Evaluation 5: Helium Permeability

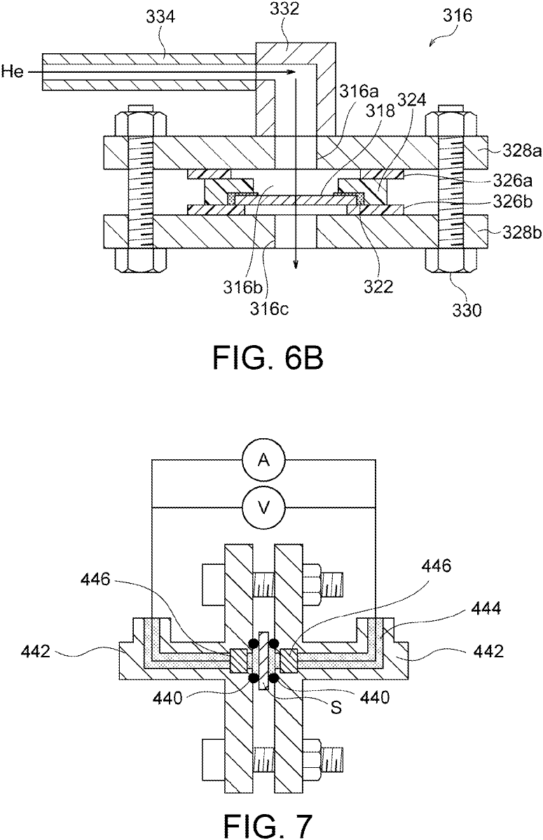

A helium permeation test was conducted to evaluate the density of the hydroxide ion-conductive separator from the viewpoint of helium permeability. The helium permeability measurement system 310 shown in FIGS. 6A and 6B was constructed. The helium permeability measurement system 310 was configured to supply helium gas from a gas cylinder filled with helium gas to a sample holder 316 through the pressure gauge 312 and a flow meter 314 (digital flow meter), and to discharge the gas by permeating from one side to the other side of the hydroxide ion-conductive separator 318 held by the sample holder 316.

The sample holder 316 had a structure including a gas supply port 316a, a sealed space 316b and a gas discharge port 316c, and was assembled as follows: An adhesive 322 was applied along the outer periphery of the hydroxide ion-conductive separator 318 and bonded to a jig 324 (made of ABS resin) having a central opening. Gaskets or sealing members 326a, 326b made of butyl rubber were disposed at the upper end and the lower end, respectively, of the jig 324, and then the outer sides of the members 326a, 326b were held with supporting members 328a, 328b (made of PTFE) each including a flange having an opening. Thus, the sealed space 316b was partitioned by the hydroxide ion-conductive separator 318, the jig 324, the sealing member 326a, and the supporting member 328a. The supporting members 328a and 328b were tightly fastened to each other with fastening means 330 with screws not to cause leakage of helium gas from portions other than the gas discharge port 316c. A gas supply pipe 334 was connected to the gas supply port 316a of the sample holder 316 assembled as above through a joint 332.

Helium gas was then supplied to the helium permeability measurement system 310 via the gas supply pipe 334, and the gas was permeated through the hydroxide ion-conductive separator 318 held in the sample holder 316. A gas supply pressure and a flow rate were then monitored with a pressure gauge 312 and a flow meter 314. After permeation of helium gas for one to thirty minutes, the helium permeability was calculated. The helium permeability was calculated from the expression of F/(P×S) where F (cm³/min) was the volume of permeated helium gas per unit time, P (atm) was the differential pressure applied to the hydroxide ion-conductive separator when helium gas permeated through, and S (cm²) was the area of the membrane through which helium gas permeates. The permeation rate F (cm³/min) of helium gas was read directly from the flow meter 314. The gauge pressure read from the pressure gauge 312 was used for the differential pressure P. Helium gas was supplied such that the differential pressure P was within the range of 0.05 to 0.90 atm.

### Evaluation 6: Measurement of Ion Conductivity

The conductivity of the hydroxide ion-conductive separator in the electrolytic solution was measured using the electrochemical measurement system shown in FIG. 4, as follows. A hydroxide ion-conductive separator sample S was sandwiched by 1-mm thick silicone packings 440 from both sides, to be assembled in a PTFE flange-type cell 442 with an inner diameter of 6 mm. As electrodes 446, nickel wire meshes of #100 mesh were assembled in the cell 442 into a cylindrical shape with a diameter of 6 mm, so that the distance between the electrodes was 2.2 mm. The cell 442 was filled with a 5.4 M KOH aqueous solution as an electrolytic solution 444. Using electrochemical measurement systems (potentiostat/galvanostat-frequency response analyzers Type 1287A and Type 1255B, manufactured by Solartron Metrology), measurement was performed under the conditions of a frequency range of 1 MHz to 0.1 Hz and an applied voltage of 10 mV, and the real axis intercept was taken as the resistance of the hydroxide ion conductive separator sample S. The same measurement as above was carried out without the hydroxide ion-conductive separator sample S, to determine a blank resistance. The difference between the resistance of the hydroxide ion-conductive separator sample S and the blank resistance was taken as the resistance of the hydroxide ion-conductive separator. The conductivity was determined using the resistance of the hydroxide ion-conductive separator obtained, and the thickness and area of the hydroxide ion-conductive separator.

### Evaluation 7: Evaluation of Alkali Resistance

A 5.4 M KOH aqueous solution containing zinc oxide at a concentration of 0.4 M was prepared. 0.5 mL of the KOH aqueous solution prepared and a hydroxide ion-conductive separator sample with a size of 2 cm square were put into a closed container made of Teflon®. Thereafter, it was maintained at 90° C. for one week (that is, 168 hours), and then the hydroxide ion-conductive separator sample was taken out of the closed container. The hydroxide ion-conductive separator sample taken out was dried overnight at room temperature. For the sample obtained, the He permeability was calculated in the same manner as in Evaluation 5, to determine whether or not the He permeability changed before and after the immersion in alkali.

### Evaluation 8: Evaluation of Dendrite Resistance (Cycle Test)

In order to evaluate the effect of suppressing short circuits due to zinc dendrites (dendrite resistance) of the hydroxide ion-conductive separator, a cycle test was performed, as follows. First, each of the positive electrode (containing nickel hydroxide and/or nickel oxyhydroxide) and the negative electrode (containing zinc and/or zinc oxide) was wrapped with a non-woven fabric, and the current extraction terminal was welded thereto. The positive electrode and the negative electrode thus prepared were opposed to each other via the hydroxide ion-conductive separator and sandwiched between laminate films provided with current outlets, and three sides of the lam inate films were heat-sealed. An electrolytic solution (a solution in which 0.4 M zinc oxide was dissolved in a 5.4 M KOH aqueous solution) was added to the cell container with the top open thus obtained, and the positive electrode and the negative electrode was sufficiently impregnated with the electrolytic solution by vacuuming or the like. Thereafter, the remaining one side of the laminate films was heat-sealed, to form a simple sealed cell. Using a charge/discharge device (TOSCAT3100, manufactured by TOYO SYSTEM CO., LTD.), the simple sealed cell was charged at 0.1 C and discharged at 0.2 C for chemical conversion. Thereafter, a 1-C charge/discharge cycle was conducted. While repeating the charge/discharge cycle under the same conditions, the voltage between the positive electrode and the negative electrode was monitored with a voltmeter, and the presence or absence of sudden voltage drops (specifically, voltage drops of 5 mV or more from the voltage that was just previously plotted) following short circuits due to zinc dendrites between the positive electrode and the negative electrode was examined and evaluated according to the following criteria.
No short circuits occurred: No sudden voltage drops as described above were observed during charging even after 300 cycles.
Short circuits occurred: Sudden voltage drops as described above were observed during charging in less than 300 cycles.

### Example A1 (Reference)

### Preparation of Porous Polymer Substrate

A commercially available polyethylene microporous membrane with a porosity of 50%, a mean pore size of 0.1 µm, and a thickness of 20 µm was prepared as a porous polymer substrate and cut out into a size of 2.0 cm × 2.0 cm.

### Titania Sol Coating on Porous Polymer Substrate

The substrate prepared by procedure (1) above was coated with a titanium oxide sol solution (M6, manufactured by Taki Chemical Co., Ltd.) by dip coating. Dip coating was performed by immersing the substrate in 100 ml of the sol solution and pulling it out perpendicularly, followed by drying at room temperature for 3 hours.

### Production of Raw Material Aqueous Solution

As raw materials, magnesium nitrate hexahydrate (Mg(NO₃)₂·6H₂O, manufactured by KANTO CHEMICAL CO., INC.) and urea ((NH₂)₂CO, manufactured by Sigma-Aldrich Corporation) were prepared. The magnesium nitrate hexahydrate was weighed to 0.015 mol/L and put into a beaker, and deionized water was added thereto so that the total amount was 75 ml. After stirring the solution obtained, urea weighed at a ratio urea/NO₃⁻ (molar ratio) of 48 was added into the solution, followed by further stirring, to obtain a raw material aqueous solution.

### Membrane Formation by Hydrothermal Treatment

The raw material aqueous solution and the dip-coated substrate were enclosed together in a closed container made of Teflon® (autoclave container, content: 100 ml, with an outer stainless steel jacket). At this time, the substrate was lifted from the bottom of the closed container made of Teflon® and fixed and installed vertically so that the solution was in contact with both sides of the substrate. Thereafter, an LDH-like compound was formed on the surface and inside the substrate by applying hydrothermal treatment at a hydrothermal temperature of 120° C. for 24 hours. After a lapse of a predetermined time, the substrate was taken out of the closed container, washed with deionized water, and dried at 70° C. for 10 hours, to form an LDH-like compound in the pores of the porous substrate. Thus, an LDH-like compound separator was obtained.

### Densification by Roll Pressing

The LDH-like compound separator was sandwiched by a pair of PET films (Lumirror®, manufactured by Toray Industries, Inc., with a thickness of 40 µm) and roll-pressed at a roll rotation speed of 3 mm/s and a roller heating temperature of 70° C. with a roll gap of 70 µm, to obtain an LDH-like compound separator that was further densified.

### Evaluation Results

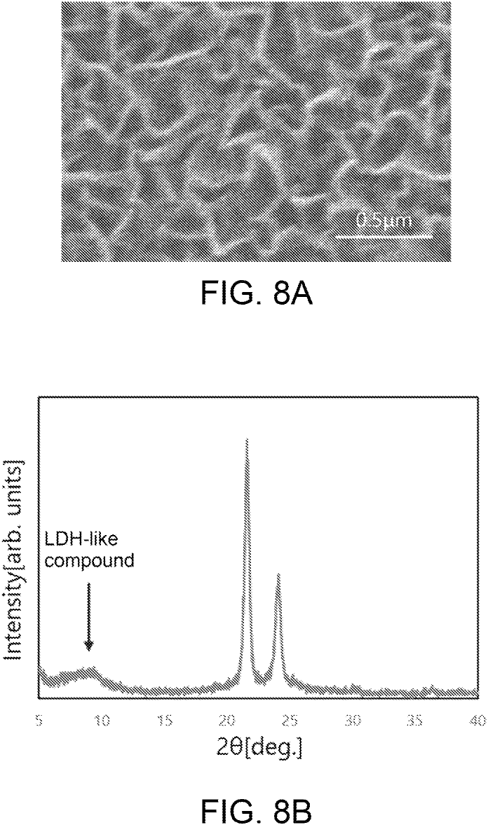

The LDH-like compound separator obtained was subjected to Evaluations 1 to 8. The results were as follows.
Evaluation 1: The SEM image of the surface microstructure of the LDH-like compound separator obtained in Example A1 (before roll pressing) was as shown in FIG. 8A.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg and Ti, which were constituent elements of the LDH-like compound, were detected on the surface of the LDH-like compound separator. Further, the composition ratio (atomic ratio) of Mg and Ti on the surface of the LDH-like compound separator, which was calculated by EDS elemental analysis, was as shown in Table 1.
Evaluation 4: FIG. 8B shows the XRD profile obtained in Example A1. In the XRD profile obtained, a peak was observed around 2θ = 9.4°. Generally, the (003) peak position of LDH is observed at 2θ = 11 to 12°, and therefore it is considered that the peak is the (003) peak of LDH shifted to the low angle side. Therefore, the peak cannot be called that of LDH, but it suggests that it is a peak derived from a compound similar to LDH (that is, an LDH-like compound). Two peaks observed at 20 < 2 θ° < 25 in the XRD profile are peaks derived from polyethylene constituting the porous substrate. Further, the interlayer distance in the layered crystal structure of the LDH-like compound was 0.94 nm.
Evaluation 5: As shown in Table 1, it was confirmed that the He permeability was 0.0 cm/min·atm, indicating that the denseness was extremely high.
Evaluation 6: As shown in Table 1, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 1, it was confirmed that short circuits due to zinc dendrites did not occur even after 300 cycles, indicating that the dendrite resistance was excellent.

### Example A2 (Reference)

An LDH-like compound separator was produced and evaluated in the same manner as in Example A1 except that the raw material aqueous solution was produced as follows in procedure (3) above, and the temperature for the hydrothermal treatment was changed to 90° C. in procedure (4) above.

### Production of Raw Material Aqueous Solution

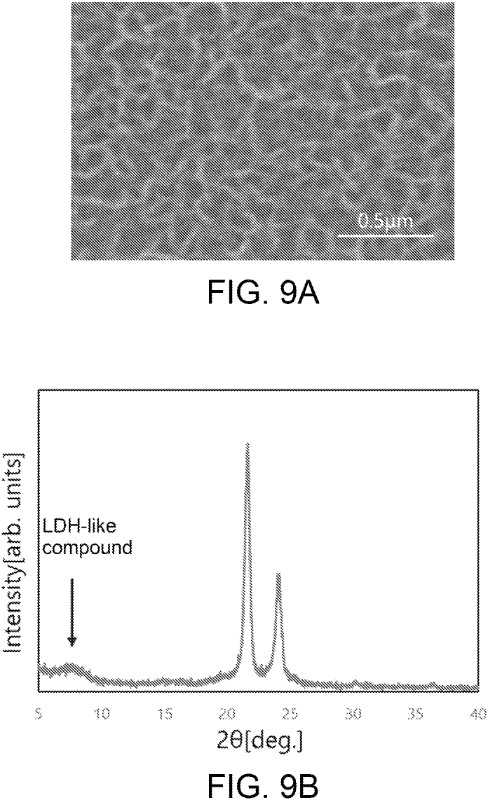

As raw materials, magnesium nitrate hexahydrate (Mg(NO₃)₂·6H₂O, manufactured by KANTO CHEMICAL CO., INC.) and urea ((NH₂)₂CO, manufactured by Sigma-Aldrich Corporation) were prepared. The magnesium nitrate hexahydrate was weighed to 0.03 mol/L and put into a beaker, and deionized water was added thereto so that the total amount was 75 ml. After stirring the solution obtained, urea weighed at a ratio urea/NO₃-(molar ratio) of 8 was added into the solution, followed by further stirring, to obtain a raw material aqueous solution.
Evaluation 1: The SEM image of the surface microstructure of the LDH-like compound separator obtained in Example A2 (before roll pressing) was as shown in FIG. 9A.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg and Ti, which were constituent elements of the LDH-like compound, were detected on the surface of the LDH-like compound separator. Further, the composition ratio (atomic ratio) of Mg and Ti on the surface of the LDH-like compound separator, which was calculated by EDS elemental analysis, was as shown in Table 1.
Evaluation 4: FIG. 9B shows the XRD profile obtained in Example A2. In the XRD profile obtained, a peak was observed around 2θ = 7.2°. Generally, the (003) peak position of LDH is observed at 2θ = 11 to 12°, and therefore it is considered that the peak is the (003) peak of LDH shifted to the low angle side. Therefore, the peak cannot be called that of LDH, but it suggests that it is a peak derived from a compound similar to LDH (that is, an LDH-like compound). Two peaks observed at 20 < 2θ° < 25 in the XRD profile are peaks derived from polyethylene constituting the porous substrate. Further, the interlayer distance in the layered crystal structure of the LDH-like compound was 1.2 nm.
Evaluation 5: As shown in Table 1, it was confirmed that the He permeability was 0.0 cm/min·atm, indicating that the denseness was extremely high.
Evaluation 6: As shown in Table 1, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 1, it was confirmed that short circuits due to zinc dendrites did not occur even after 300 cycles, indicating that the dendrite resistance was excellent.

### Example A3 (Reference)

An LDH-like compound separator was produced and evaluated in the same manner as in Example A1 except that the porous polymer substrate was coated with titania and yttria sols as follows, instead of procedure (2) above.

### Titania-Yttria Sol Coating on Porous Polymer Substrate

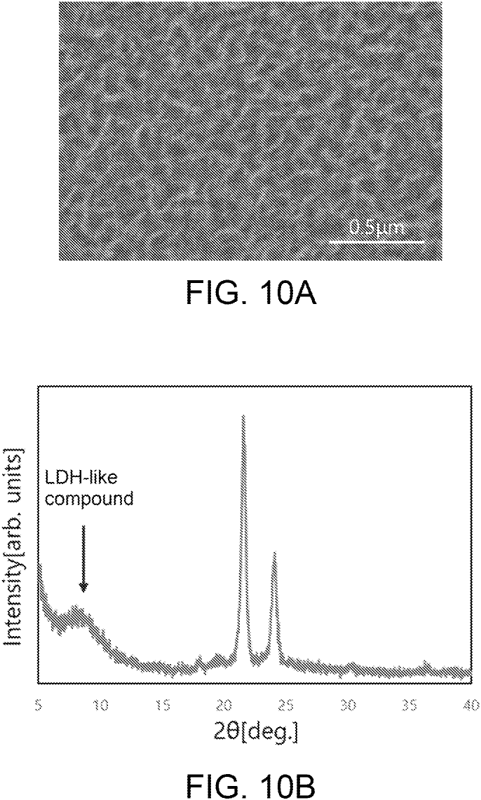

A titanium oxide sol solution (M6, manufactured by Taki Chemical Co., Ltd.) and a yttrium sol were mixed at a molar ratio Ti/Y of 4. The substrate prepared in procedure (1) above was coated with the mixed solution obtained by dip coating. Dip coating was performed by immersing the substrate in 100 ml of the mixed solution and pulling it out perpendicularly, followed by drying at room temperature for 3 hours.
Evaluation 1: The SEM image of the surface microstructure of the LDH-like compound separator obtained in Example A3 (before roll pressing) was as shown in FIG. 10A.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg, Ti, and Y, which were constituent elements of the LDH-like compound, were detected on the surface of the LDH-like compound separator. Further, the composition ratio (atomic ratio) of Mg, Ti, and Y on the surface of the LDH-like compound separator, which was calculated by EDS elemental analysis, was as shown in Table 1.
Evaluation 4: FIG. 10B shows the XRD profile obtained in Example A3. In the XRD profile obtained, a peak was observed around 2θ = 8.0°. Generally, the (003) peak position of LDH is observed at 2θ = 11 to 12°, and therefore it is considered that the peak is the (003) peak of LDH shifted to the low angle side. Therefore, the peak cannot be called that of LDH, but it suggests that it is a peak derived from a compound similar to LDH (that is, an LDH-like compound). Two peaks observed at 20 < 2 θ° < 25 in the XRD profile are peaks derived from polyethylene constituting the porous substrate. Further, the interlayer distance in the layered crystal structure of the LDH-like compound was 1.1 nm.
Evaluation 5: As shown in Table 1, it was confirmed that the He permeability was 0.0 cm/min·atm, indicating that the denseness was extremely high.
Evaluation 6: As shown in Table 1, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 1, it was confirmed that short circuits due to zinc dendrites did not occur even after 300 cycles, indicating that the dendrite resistance was excellent.

### Example A4 (Reference)

An LDH-like compound separator was produced and evaluated in the same manner as in Example A1 except that the porous polymer substrate was coated with titania, yttria, and alumina sols as follows, instead of procedure (2) above.

### Titania-Yttria-Alumina Sol Coating on Porous Polymer Substrate

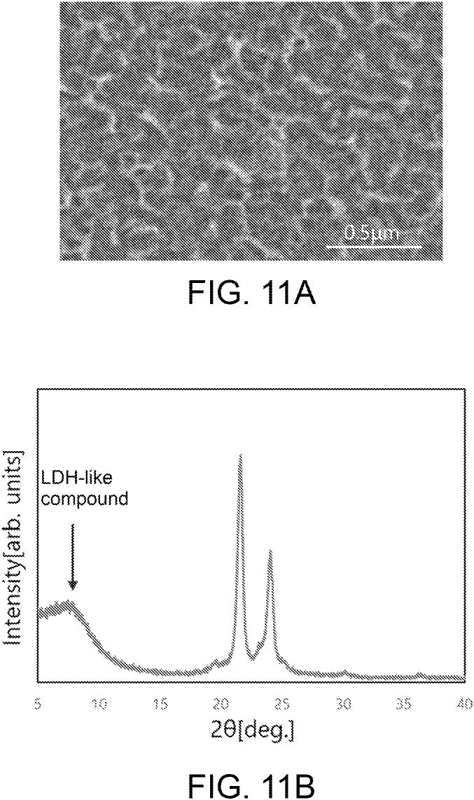

A titanium oxide sol solution (M6, manufactured by Taki Chemical Co., Ltd.), a yttrium sol, and an amorphous alumina solution (Al-ML15, manufactured by Taki Chemical Co., Ltd.) were mixed at a molar ratio Ti/(Y + Al) of 2 and a molar ratio Y/Al of 8. The substrate prepared in procedure (1) above was coated with the mixed solution by dip coating. Dip coating was performed by immersing the substrate in 100 ml of the mixed solution and pulling it out perpendicularly, followed by drying at room temperature for 3 hours.
Evaluation 1: The SEM image of the surface microstructure of the LDH-like compound separator obtained in Example A4 (before roll pressing) was as shown in FIG. 11A.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg, Al, Ti, and Y, which were constituent elements of the LDH-like compound, were detected on the surface of the LDH-like compound separator. Further, the composition ratio (atomic ratio) of Mg, Al, Ti, and Y on the surface of the LDH-like compound separator, which was calculated by EDS elemental analysis, was as shown in Table 1.
Evaluation 4: FIG. 11B shows the XRD profile obtained in Example A4. In the XRD profile obtained, a peak was observed around 2θ = 7.8°. Generally, the (003) peak position of LDH is observed at 2θ = 11 to 12°, and therefore it is considered that the peak is the (003) peak of LDH shifted to the low angle side. Therefore, the peak cannot be called that of LDH, but it suggests that it is a peak derived from a compound similar to LDH (that is, an LDH-like compound). Two peaks observed at 20 < 2 θ° < 25 in the XRD profile are peaks derived from polyethylene constituting the porous substrate. Further, the interlayer distance in the layered crystal structure of the LDH-like compound was 1.1 nm.
Evaluation 5: As shown in Table 1, it was confirmed that the He permeability was 0.0 cm/min·atm, indicating that the denseness was extremely high.
Evaluation 6: As shown in Table 1, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 1, it was confirmed that short circuits due to zinc dendrites did not occur even after 300 cycles, indicating that the dendrite resistance was excellent.

### Example A5 (Reference)

An LDH-like compound separator was produced and evaluated in the same manner as in Example A1 except that the porous polymer substrate was coated with titania and yttria sols as follows, instead of procedure (2) above, and the raw material aqueous solution was produced as follows in procedure (3) above.

### Titania-Yttria Sol Coating on Porous Polymer Substrate

A titanium oxide sol solution (M6, manufactured by Taki Chemical Co., Ltd.) and a yttrium sol were mixed at a molar ratio Ti/Y of 18. The substrate prepared in procedure (1) above was coated with the mixed solution obtained by dip coating. Dip coating was performed by immersing the substrate in 100 ml of the mixed solution and pulling it out perpendicularly, followed by drying at room temperature for 3 hours.

### Production of Raw Material Aqueous Solution

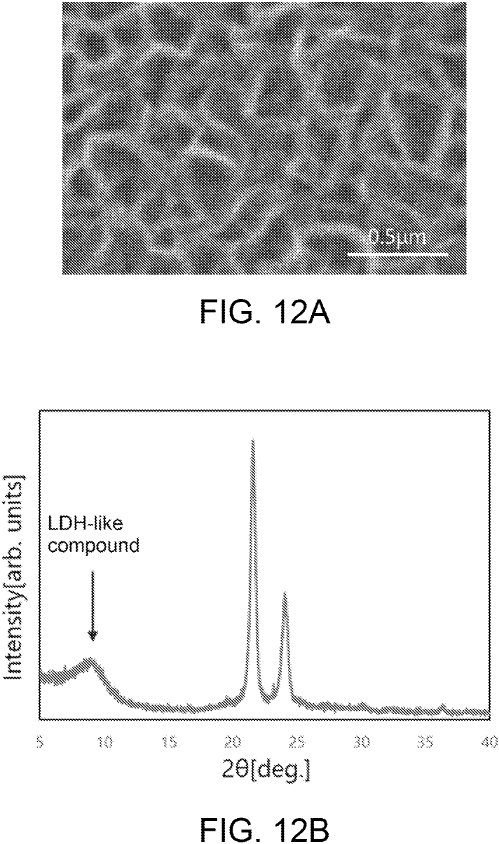

As raw materials, magnesium nitrate hexahydrate (Mg(NO₃)₂·6H₂O, manufactured by KANTO CHEMICAL CO., INC.) and urea ((NH₂)₂CO, manufactured by Sigma-Aldrich Corporation) were prepared. The magnesium nitrate hexahydrate was weighed to 0.0075 mol/L and put into a beaker, and deionized water was added thereto so that the total amount was 75 ml. Then, the solution obtained was stirred. Urea weighed at a ratio urea/NO₃⁻ (molar ratio) = 96 was added into the solution, followed by further stirring, to obtain a raw material aqueous solution.
Evaluation 1: The SEM image of the surface microstructure of the LDH-like compound separator obtained in Example A5 (before roll pressing) was as shown in FIG. 12A.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg, Ti, and Y, which were constituent elements of the LDH-like compound, were detected on the surface of the LDH-like compound separator. Further, the composition ratio (atomic ratio) of Mg, Ti, and Y on the surface of the LDH-like compound separator, which was calculated by EDS elemental analysis, was as shown in Table 1.
Evaluation 4: FIG. 12B shows the XRD profile obtained in Example A5. In the XRD profile obtained, a peak was observed around 2θ = 8.9°. Generally, the (003) peak position of LDH is observed at 2θ = 11 to 12°, and therefore it is considered that the peak is the (003) peak of LDH shifted to the low angle side. Therefore, the peak cannot be called that of LDH, but it suggests that it is a peak derived from a compound similar to LDH (that is, an LDH-like compound). Two peaks observed at 20 < 2 θ° < 25 in the XRD profile are peaks derived from polyethylene constituting the porous substrate. Further, the interlayer distance in the layered crystal structure of the LDH-like compound was 0.99 nm.
Evaluation 5: As shown in Table 1, it was confirmed that the He permeability was 0.0 cm/min·atm, indicating that the denseness was extremely high.
Evaluation 6: As shown in Table 1, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 1, it was confirmed that short circuits due to zinc dendrites did not occur even after 300 cycles, indicating that the dendrite resistance was excellent.

### Example A6 (Reference)

An LDH-like compound separator was produced and evaluated in the same manner as in Example A1 except that the porous polymer substrate was coated with titania and alumina sols as follows, instead of procedure (2) above, and the raw material aqueous solution was produced as follows in procedure (3) above.

### Titania-Alumina Sol Coating on Porous Polymer Substrate

A titanium oxide sol solution (M6, manufactured by Taki Chemical Co., Ltd.) and an amorphous alumina solution (Al-ML15, manufactured by Taki Chemical Co., Ltd.) were mixed at a molar ratio Ti/Al of 18. The substrate prepared in procedure (1) above was coated with the mixed solution by dip coating. Dip coating was performed by immersing the substrate in 100 ml of the mixed solution and pulling it out perpendicularly, followed by drying at room temperature for 3 hours.

### Production of Raw Material Aqueous Solution

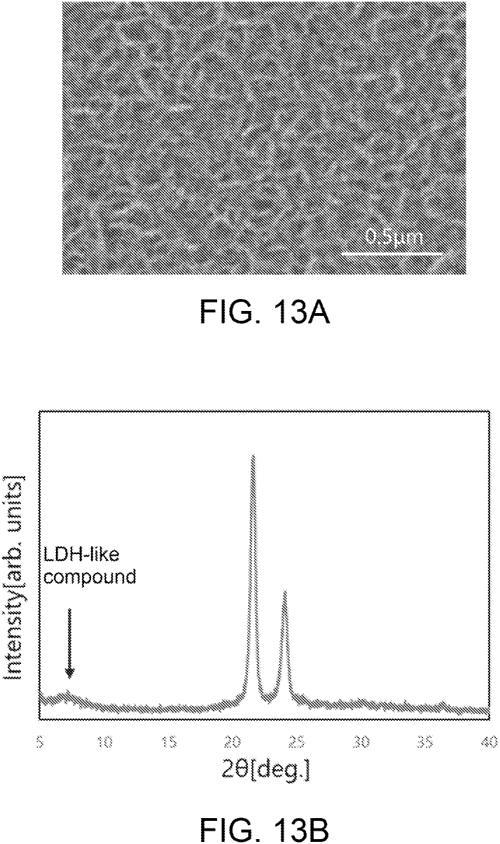

As raw materials, magnesium nitrate hexahydrate (Mg(NO₃)₂·6H₂O, manufactured by KANTO CHEMICAL CO., INC.), yttrium nitrate n hydrate (Y(NO₃)₃·nH₂O, manufactured by FUJIFILM Wako Pure Chemical Corporation), and urea ((NH₂)₂CO, manufactured by Sigma-Aldrich Corporation) were prepared. The magnesium nitrate hexahydrate was weighed to 0.0015 mol/L and put into a beaker. Further, the yttrium nitrate n hydrate was weighed to 0.0075 mol/L and put into the beaker, and deionized water was added thereto so that the total amount was 75 ml. Then, the solution obtained was stirred. Urea weighed at a ratio urea/NO₃⁻ (molar ratio) of 9.8 was added into the solution, followed by further stirring, to obtain a raw material aqueous solution.
Evaluation 1: The SEM image of the surface microstructure of the LDH-like compound separator obtained in Example A6 (before roll pressing) was as shown in FIG. 13A.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg, Al, Ti, and Y, which were constituent elements of the LDH-like compound, were detected on the surface of the LDH-like compound separator. Further, the composition ratio (atomic ratio) of Mg, Al, Ti, and Y on the surface of the LDH-like compound separator, which was calculated by EDS elemental analysis, was as shown in Table 1.
Evaluation 4: FIG. 13B shows the XRD profile obtained in Example A6. In the XRD profile obtained, a peak was observed around 2θ = 7.2°. Generally, the (003) peak position of LDH is observed at 2θ = 11 to 12°, and therefore it is considered that the peak is the (003) peak of LDH shifted to the low angle side. Therefore, the peak cannot be called that of LDH, but it suggests that it is a peak derived from a compound similar to LDH (that is, an LDH-like compound). Two peaks observed at 20 < 2 θ° < 25 in the XRD profile are peaks derived from polyethylene constituting the porous substrate. Further, the interlayer distance in the layered crystal structure of the LDH-like compound was 1.2 nm.
Evaluation 5: As shown in Table 1, it was confirmed that the He permeability was 0.0 cm/min·atm, indicating that the denseness was extremely high.
Evaluation 6: As shown in Table 1, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 1, it was confirmed that short circuits due to zinc dendrites did not occur even after 300 cycles, indicating that the dendrite resistance was excellent.

### Example A7 (Reference)

An LDH-like compound separator was produced and evaluated in the same manner as in Example A6 except that the raw material aqueous solution was produced as follows in procedure (3) above.

### Production of Raw Material Aqueous Solution

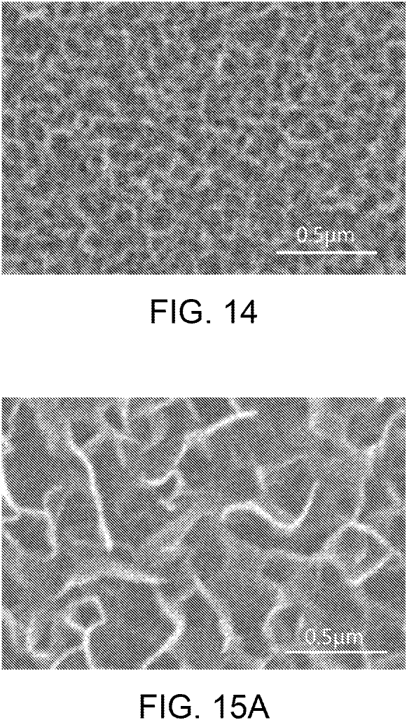

As raw materials, magnesium nitrate hexahydrate (Mg(NO₃)₂·6H₂O, manufactured by KANTO CHEMICAL CO., INC.), yttrium nitrate n hydrate (Y(NO₃)₃·nH₂O, manufactured by FUJIFILM Wako Pure Chemical Corporation), and urea ((NH₂)₂CO, manufactured by Sigma-Aldrich Corporation) were prepared. The magnesium nitrate hexahydrate was weighed to 0.0075 mol/L and put into a beaker. Further, the yttrium nitrate n hydrate was weighed to 0.0075 mol/L and put into the beaker, and deionized water was added thereto so that the total amount was 75 ml. Then, the solution obtained was stirred. Urea weighed at a ratio urea/NO₃⁻ (molar ratio) of 25.6 was added into the solution, followed by further stirring, to obtain a raw material aqueous solution.
Evaluation 1: The SEM image of the surface microstructure of the LDH-like compound separator obtained in Example A7 (before roll pressing) was as shown in FIG. 14.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg, Al, Ti, and Y, which were constituent elements of the LDH-like compound, were detected on the surface of the LDH-like compound separator. Further, the composition ratio (atomic ratio) of Mg, Al, Ti, and Y on the surface of the LDH-like compound separator, which was calculated by EDS elemental analysis, was as shown in Table 1.
Evaluation 5: As shown in Table 1, it was confirmed that the He permeability was 0.0 cm/min·atm, indicating that the denseness was extremely high.
Evaluation 6: As shown in Table 1, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 1, it was confirmed that short circuits due to zinc dendrites did not occur even after 300 cycles, indicating that the dendrite resistance was excellent.

### Example A8 (Comparison)

An LDH separator was produced and evaluated in the same manner as in Example A1 except that alumina sol coating was performed as follows, instead of procedure (2) above.

### Alumina Sol Coating on Porous Polymer Substrate

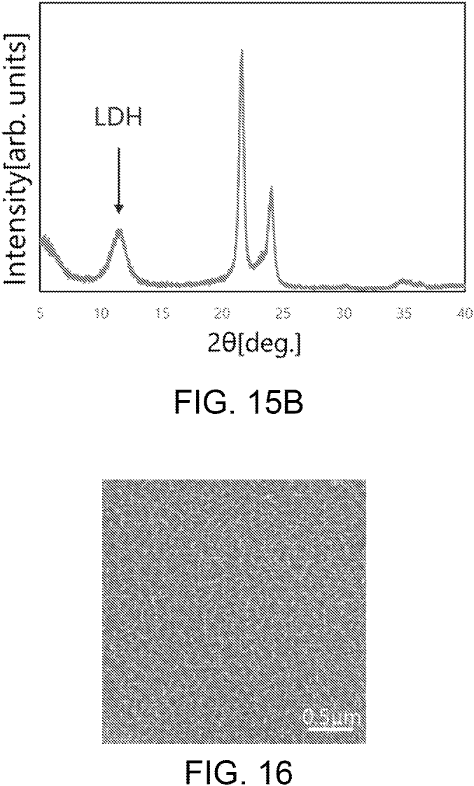

The substrate prepared in procedure (1) above was coated with an amorphous alumina sol (AI-ML15, manufactured by Taki Chemical Co., Ltd.) by dip coating. Dip coating was performed by immersing the substrate in 100 ml of the amorphous alumina sol and pulling it out perpendicularly, followed by drying at room temperature for 3 hours.
Evaluation 1: The SEM image of the surface microstructure of the LDH separator obtained in Example A8 (before roll pressing) was as shown in FIG. 15A.
Evaluation 2: From the result that layered plaids could be observed, it was confirmed that the portion of the LDH separator other than the porous substrate was a compound with a layered crystal structure.
Evaluation 3: As a result of EDS elemental analysis, Mg and Al, which were constituent elements of LDH, were detected on the surface of the LDH separator. Further, the composition ratio (atomic ratio) of Mg and Al on the surface of the LDH separator, which was calculated by EDS elemental analysis, was as shown in Table 1.
Evaluation 4: FIG. 15B shows the XRD profile obtained in Example A8. From a peak around 2θ = 11.5° in the XRD profile obtained, the LDH separator obtained in Example A8 was identified to be an LDH (hydrotalcite compound). This identification was performed using the diffraction peak of the LDH (hydrotalcite compound) described in JCPDS card NO. 35-0964. Two peaks observed at 20 < 2 θ° < 25 in the XRD profile are peaks derived from polyethylene constituting the porous substrate.
Evaluation 5: As shown in Table 1, it was confirmed that the He permeability was 0.0 cm/min·atm, indicating that the denseness was extremely high.
Evaluation 6: As shown in Table 1, it was confirmed that the ion conductivity was high.
Evaluation 7: As a result of the immersion in alkali at a high temperature of 90° C. for one week, the He permeability that was 0.0 cm/min·atm in Evaluation 5 was over 10 cm/min·atm, revealing that the alkali resistance was poor.
Evaluation 8: As shown in Table 1, short circuits due to zinc dendrites occurred in less than 300 cycles, revealing that the dendrite resistance was poor.

TABLE 1

| | LDH-like compound or composition of LDH | Evaluation of hydroxide ion-conductive separator | | | | |
|---|---|---|---|---|---|---|
| | | Composition ratio (Atomic ratio) | He permeation (cm/min·atm) | Ion conductivity (mS/cm) | Alkali resistance | Dendrite resistance |
| | | | | | Presence or absence of change in He permeability | Presence or absence of short circuits |
| Example A1^{#} | Mg-Ti-LDH-like | Mg:Ti=6:94 | 0.0 | 3.0 | Absent | Absent |
| Example A2^{#} | Mg-Ti-LDH-like | Mg:Ti=20:80 | 0.0 | 2.0 | Absent | Absent |
| Example A3^{#} | Mg-(Ti,Y)-LDH-like | Mg:Ti:Y=5:83:12 | 0.0 | 3.0 | Absent | Absent |
| Example A4^{#} | Mg-(Ti,Y,Al)-LDH-like | Mg:Al:Ti:Y=7:3:79:12 | 0.0 | 3.1 | Absent | Absent |
| Example A5^{#} | Mg-(Ti,Y)- LDH-like | Mg:Ti:Y=6:88:6 | 0.0 | 3.0 | Absent | Absent |
| Example A6^{#} | Mg-(Ti,Y,Al)-LDH-like | Mg:Al:Ti:Y=5:2:67:25 | 0.0 | 3.1 | Absent | Absent |
| Example A7^{#} | Mg-(Ti,Y,Al)-LDH-like | Mg:Al:Ti:Y=15:1:47:37 | 0.0 | 2.9 | Absent | Absent |
| Example A8* | Mg-Al-LDH | Mg:Al=67:32 | 0.0 | 2.7 | Present | Present |

Symbol ^{#} represents a reference example.
Symbol * represents a comparative example.

### Examples B1 to B9

Examples B1 to B9 shown below are reference examples for LDH-like compound separators. The method for evaluating the LDH-like compound separators produced in the following examples was the same as in Examples A1 to A8, except that the composition ratio (atomic ratio) of Mg: Al: Ti: Y: additive element M was calculated in Evaluation 3.

### Example B1 (Reference)

### Preparation of Polymer Porous Substrate

A commercially available polyethylene microporous membrane having a porosity of 50%, an average pore diameter of 0.1 µm, and a thickness of 20 µm was prepared as a polymer porous substrate and cut out to a size of 2.0 cm × 2.0 cm.

### Coating of Titania▪ Yttria▪ Alumina Sol on Polymer Porous Substrate

A titanium dioxide sol solution (M6, manufactured by Taki Chemical Co., Ltd.), an yttrium sol, and an amorphous alumina solution (Al-ML15, manufactured by Taki Chemical Co. Ltd.) were mixed so that Ti/(Y + Al) (molar ratio) = 2, and Y/Al (molar ratio) = 8. The substrate prepared in (1) above was coated with the mixed solution by dip coating. The dip coating was carried out by dipping the substrate into 100 ml of the mixed solution, pulling up the coating substrate vertically, and allowing it to dry for 3 hours at room temperature.

### Preparation of Raw Material Aqueous Solution (I)

Magnesium nitrate hexahydrate (Mg(NO₃)₂·6H₂O, manufactured by Kanto Chemical Co., Inc.) and urea ((NH₂)₂CO, manufactured by Sigma-Aldrich Co. LLC) were prepared as raw materials. Magnesium nitrate hexahydrate was weighed so that it would be 0.015 mol/L and placed in a beaker, and ion-exchanged water was added therein to make a total amount of 75 ml. After stirring the obtained solution, the urea weighed at a ratio that urea/NO₃⁻ (molar ratio) = 48 was added to the solution, and the mixture was further stirred to obtain a raw material aqueous solution (I).

### Membrane Formation by Hydrothermal Treatment

Both the raw material aqueous solution (I) and the dip-coated substrate were sealed in a Teflon® airtight container (autoclave container having a content of 100 ml and an outer side jacket made of stainless steel). At this time, a substrate was fixed while being floated from the bottom of the Teflon® airtight container, and installed vertically so that the solution was in contact with both sides of the substrate. Thereafter, an LDH-like compound was formed on the surface and the inside of the substrate by subjecting it to hydrothermal treatment at a hydrothermal temperature of 120° C. for 22 hours. With an elapse of the predetermined time, the substrate was taken out from the airtight container, washed with ion-exchanged water, and dried at 70° C. for 10 hours to form an LDH-like compound inside the pores of the porous substrate.

### Preparation of Raw Material Aqueous Solution (II)

Indium sulfate n-hydrate (In₂(SO₄)₃▪nH₂O, manufactured by FUJIFILM Wako Pure Chemical Corporation) was prepared as the raw material. The Indium sulfate n-hydrate was weighed so that it would be 0.0075 mol/L and placed in a beaker, to which ion-exchanged water was added to make a total volume 75 ml. The resulting solution was stirred to obtain a raw material aqueous solution (II).

### Addition of Indium by Immersion Treatment

In a Teflon® airtight container (autoclave container having a content of 100 ml and an outer side jacket made of stainless steel), the raw material aqueous solution (II) and the LDH-like compound separator obtained in (4) above were enclosed together. At that time, a substrate was fixed while being floated from the bottom of the Teflon® airtight container and arranged vertically so that the solution was in contact with both sides of the substrate. Thereafter Indium was added on the substrate by subjecting it to immersion treatment at 30° C. for 1 hour. With an elapse of the predetermined time, the substrate was taken out from the airtight container, washed with ion-exchanged water, and dried at 70° C. for 10 hours to obtain an LDH-like compound separator with Indium added thereon.

### Densification by Roll Pressing

The LDH-like compound separator was sandwiched between a pair of PET films (Lumiler® manufactured by Toray Industries, Inc., thickness of 40 µm), and roll-pressed at a roll rotation speed of 3 mm/s, a roller heating temperature of 70° C., and a roll gap of 70 µm to obtain a further densified LDH-like compound separator.

### Evaluation Result

Various evaluations were conducted on the LDH-like compound separators obtained. The results were as follows.
Evaluation 1: The SEM image of surface microstructure of the LDH-like compound separator obtained in Example B1 (before having been roll pressed) was shown in FIG. 16.
Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Al, Ti, Y, and In were detected on the surface of the LDH-like compound separator. Moreover, the composition ratio (atomic ratio) of Al, Ti, Y, and In on the surface of the LDH-like compound separator, calculated by EDS elemental analysis was as shown in Table 2.
Evaluation 5: As shown in Table 2, the extremely high denseness was confirmed by a He permeability of 0.0 cm/min▪ atm.
Evaluation 6: As shown in Table 2, the high ionic conductivity was confirmed.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 2, the excellent dendrite resistance was confirmed in that there was no short circuit due to zinc dendrites even after 300 cycles.

### Example B2 (Reference)

An LDH-like compound separator was fabricated and evaluated in the same manner as in Example B1 except that the time of immersion treatment was changed to 24 hours in indium addition by the immersion treatment of (6) above.
Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Al, Ti, Y, and In were detected on the surface of the LDH-like compound separator. Moreover, the composition ratio (atomic ratio) of Al, Ti, Y, and In on the surface of the LDH-like compound separator, calculated by EDS elemental analysis was as shown in Table 2.
Evaluation 5: As shown in Table 2, the extremely high denseness was confirmed by a He permeability of 0.0 cm/min▪atm.
Evaluation 6: The high ionic conductivity was confirmed, as shown in Table 2.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 2, no short circuit caused by zinc dendrite occurred even after 300 cycles, confirming the excellent dendrite resistance.

### Example B3 (Reference)

An LDH-like compound separator was fabricated and evaluated in the same manner as in Example B1 except that the titania-yttria sol coating was carried out as follows instead of (2) above.

### Coating of Titania-Yttria Sol on Polymer Porous Substrate

A titanium dioxide sol solution (M6, manufactured by Taki Chemical Co., Ltd.) and an yttrium sol were mixed so that Ti/Y (molar ratio) = 2. The substrate prepared in (1) above was coated with the obtained mixed solution by dip coating. The dip coating was carried out by dipping the substrate into 100 ml of the mixed solution, pulling up the coating substrate vertically, and allowing it to dry for 3 hours at room temperature.
Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Ti, Y, and In were detected on the surface of the LDH-like compound separator. Moreover, the composition ratio (atomic ratio) of Ti, Y, and In on the surface of the LDH-like compound separator, calculated by EDS elemental analysis was as shown in Table 2.
Evaluation 5: As shown in Table 2, the extremely high denseness was confirmed by a He permeability of 0.0 cm/min▪atm.
Evaluation 6: The high ionic conductivity was confirmed, as shown in Table 2.
Evaluation 7: The He permeability after alkaline immersion was 0.0 cm/min▪ atm, as in Evaluation 5, and the He permeability remained unchanged even over one week of alkaline immersion at the elevated temperature of 90° C., confirming the excellent alkali resistance.
Evaluation 8: As shown in Table 2, no short circuit caused by zinc dendrite occurred even after 300 cycles, confirming the excellent dendrite resistance.

### Example B4 (Reference)

An LDH-like compound separator was fabricated and evaluated in the same manner as in Example B1 except that the preparation of the raw material aqueous solution (II) in (5) above was carried out as follows, and bismuth was added by immersion treatment as follows instead of (6) above.

### Preparation of Raw Material Aqueous Solution (II)

Bismuth nitrate pentahydrate (Bi(NO₃)₃▪5H₂O) was prepared as the raw material. The bismuth nitrate pentahydrate was weighed so that it would be 0.00075 mol/L and placed in a beaker, to which ion-exchanged water was added to make a total volume 75 ml. The resulting solution was stirred to obtain a raw material aqueous solution (II).

### Addition of Bismuth by Immersion Treatment

In a Teflon® airtight container (autoclave container having a content of 100 ml and an outer side jacket made of stainless steel), the raw material aqueous solution (II) and the LDH-like compound separator obtained in (4) above were enclosed together. At that time, a substrate was fixed while being floated from the bottom of the Teflon® airtight container and arranged vertically so that the solution was in contact with both sides of the substrate. Thereafter bismuth was added on the substrate by subjecting it to immersion treatment at 30° C. for 1 hour. With an elapse of the predetermined time, the substrate was taken out from the airtight container, washed with ion-exchanged water, and dried at 70° C. for 10 hours to obtain an LDH-like compound separator with bismuth added thereon.
Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Mg, Al, Ti, Y, and Bi were detected on the surface of the LDH-like compound separator. Moreover, the composition ratio (atomic ratio) of Mg, Al, Ti, Y, and Bi on the surface of the LDH-like compound separator, calculated by EDS elemental analysis was as shown in Table 2.
Evaluation 5: As shown in Table 2, the extremely high denseness was confirmed by a He permeability of 0.0 cm/min▪ atm.
Evaluation 6: The high ionic conductivity was confirmed, as shown in Table 2.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 2, no short circuit caused by zinc dendrite occurred even after 300 cycles, confirming the excellent dendrite resistance.

### Example B5 (Reference)

An LDH-like compound separator was fabricated and evaluated in the same manner as in Example B4 except that the time of immersion treatment was changed to 12 hours in bismuth addition by the immersion treatment described above.
Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Mg, Al, Ti, Y, and Bi were detected on the surface of the LDH-like compound separator. Moreover, the composition ratio (atomic ratio) of Mg, Al, Ti, Y, and Bi on the surface of the LDH-like compound separator, calculated by EDS elemental analysis was as shown in Table 2.
Evaluation 5: As shown in Table 2, the extremely high denseness was confirmed by a He permeability of 0.0 cm/min▪atm.
Evaluation 6: The high ionic conductivity was confirmed, as shown in Table 2.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 2, no short circuit caused by zinc dendrite occurred even after 300 cycles, confirming the excellent dendrite resistance.

### Example B6 (Reference)

An LDH-like compound separator was fabricated and evaluated in the same manner as in Example B4 except that the time of immersion treatment was changed to 24 hours in bismuth addition by the immersion treatment described above.
Evaluation 2: From the observation result of layered lattice stripes, the portion other than the porous substrate of the LDH-like compound separator was confirmed to be a compound having a layered crystal structure
Evaluation 3: As a result of EDS elemental analysis, the constituent elements of the LDH-like compound that were Mg, Al, Ti, Y, and Bi were detected on the surface of the LDH-like compound separator. Moreover, the composition ratio (atomic ratio) of Mg, Al, Ti, Y, and Bi on the surface of the LDH-like compound separator, calculated by EDS elemental analysis was as shown in Table 2.
Evaluation 5: As shown in Table 2, the extremely high denseness was confirmed by a He permeability of 0.0 cm/min▪ atm.
Evaluation 6: The high ionic conductivity was confirmed, as shown in Table 2.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 2, no short circuit caused by zinc dendrite occurred even after 300 cycles, confirming the excellent dendrite resistance.

### Example B7 (Reference)

An LDH-like compound separator was fabricated and evaluated in the same manner as in Example B1 except that the preparation of the raw material aqueous solution (II) in (5) above was carried out as follows, and calcium was added by immersion treatment as follows instead of (6) above.

### Preparation of Raw Material Aqueous Solution (II)

Calcium nitrate tetrahydrate (Ca(NO₃)₂▪4H₂O) was prepared as the raw material. The calcium nitrate tetrahydrate was weighed so that it would be 0.015 mol/L and placed in a beaker, to which ion-exchanged water was added to make a total volume 75 ml. The resulting solution was stirred to obtain a raw material aqueous solution (II).

### Addition of Calcium by Immersion Treatment

In a Teflon® airtight container (autoclave container having a content of 100 ml and an outer side jacket made of stainless steel), the raw material aqueous solution (II) and the LDH-like compound separator obtained in (4) above were enclosed together. At that time, a substrate was fixed while being floated from the bottom of the Teflon® airtight container and arranged vertically so that the solution was in contact with both sides of the substrate. Thereafter calcium was added on the substrate by subjecting it to immersion treatment at 30° C. for 6 hours. With an elapse of the predetermined time, the substrate was taken out from the airtight container, washed with ion-exchanged water, and dried at 70° C. for 10 hours to obtain an LDH-like compound separator with calcium added thereon.
Evaluation 2: From the observation result of layered lattice stripes, the portion other than the porous substrate of the LDH-like compound separator was confirmed to be a compound having a layered crystal structure
Evaluation 3: As a result of EDS elemental analysis, the constituent elements of the LDH-like compound that were Mg, Al, Ti, Y, and Ca were detected on the surface of the LDH-like compound separator. Moreover, the composition ratio (atomic ratio) of Mg, Al, Ti, Y, and Ca on the surface of the LDH-like compound separator, calculated by EDS elemental analysis was as shown in Table 2.
Evaluation 5: As shown in Table 2, the extremely high denseness was confirmed by a He permeability of 0.0 cm/min▪atm.
Evaluation 6: The high ionic conductivity was confirmed, as shown in Table 2.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 2, no short circuit caused by zinc dendrite occurred even after 300 cycles, confirming the excellent dendrite resistance.

### Example B8 (Reference)

An LDH-like compound separator was fabricated and evaluated in the same manner as in Example B1 except that the preparation of the raw material aqueous solution (II) in (5) above was carried out as follows, and strontium was added by immersion treatment as follows instead of (6) above.

### Preparation of Raw Material Aqueous Solution (II)

Strontium nitrate (Sr(NO₃)₂) was prepared as the raw material. The strontium nitrate was weighed so that it would be 0.015 mol/L and placed in a beaker, to which ion-exchanged water was added to make a total volume 75 ml. The resulting solution was stirred to obtain a raw material aqueous solution (II).

### Addition of Strontium by Immersion Treatment

In a Teflon® airtight container (autoclave container having a content of 100 ml and an outer side jacket made of stainless steel), the raw material aqueous solution (II) and the LDH-like compound separator obtained in (4) above were enclosed together. At that time, a substrate was fixed while being floated from the bottom of the Teflon® airtight container and arranged vertically so that the solution was in contact with both sides of the substrate. Thereafter strontium was added on the substrate by subjecting it to immersion treatment at 30° C. for 6 hours. With an elapse of the predetermined time, the substrate was taken out from the airtight container, washed with ion-exchanged water, and dried at 70° C. for 10 hours to obtain an LDH-like compound separator with strontium added thereon.
Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Mg, Al, Ti, Y, and Sr were detected on the surface of the LDH-like compound separator. Moreover, the composition ratio (atomic ratio) of Mg, Al, Ti, Y, and Sr on the surface of the LDH-like compound separator, calculated by EDS elemental analysis was as shown in Table 2.
Evaluation 5: As shown in Table 2, the extremely high denseness was confirmed by a He permeability of 0.0 cm/min▪atm.
Evaluation 6: The high ionic conductivity was confirmed, as shown in Table 2.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 2, no short circuit caused by zinc dendrite occurred even after 300 cycles, confirming the excellent dendrite resistance.

### Example B9 (Reference)

An LDH-like compound separator was fabricated and evaluated in the same manner as in Example B1 except that the preparation of the raw material aqueous solution (II) in (5) above was carried out as follows, and barium was added by immersion treatment as follows instead of (6) above.

### Preparation of Raw Material Aqueous Solution (II)

Barium nitrate (Ba(NO₃)₂) was prepared as the raw material. The barium nitrate was weighed so that it would be 0.015 mol/L and placed in a beaker, to which ion-exchanged water was added to make a total volume 75 ml. The resulting solution was stirred to obtain a raw material aqueous solution (II).

### Addition of Barium by Immersion Treatment

In a Teflon® airtight container (autoclave container having a content of 100 ml and an outer side jacket made of stainless steel), the raw material aqueous solution (II) and the LDH-like compound separator obtained in (4) above were enclosed together. At that time, a substrate was fixed while being floated from the bottom of the Teflon® airtight container and arranged vertically so that the solution was in contact with both sides of the substrate. Thereafter barium was added on the substrate by subjecting it to immersion treatment at 30° C. for 6 hours. With an elapse of the predetermined time, the substrate was taken out from the airtight container, washed with ion-exchanged water, and dried at 70° C. for 10 hours to obtain an LDH-like compound separator with barium added thereon.
Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Al, Ti, Y, and Ba were detected on the surface of the LDH-like compound separator. Moreover, the composition ratio (atomic ratio) of Al, Ti, Y, and Ba on the surface of the LDH-like compound separator, calculated by EDS elemental analysis was as shown in Table 2.
Evaluation 5: As shown in Table 2, the extremely high denseness was confirmed by a He permeability of 0.0 cm/min▪atm.
Evaluation 6: The high ionic conductivity was confirmed, as shown in Table 2.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 2, no short circuit caused by zinc dendrite occurred even after 300 cycles, confirming the excellent dendrite resistance.

TABLE 2

| | LDH-like compound or LDH composition | Composition ratio (atomic ratio relative to 100 of the total amount of Mg+Al+Ti+Y+M) | M/(Mg+Al +Ti+Y+M) | Evaluation of hydroxide ion-conductive separator | | | |
|---|---|---|---|---|---|---|---|
| | | | | He permeability (cm/min·atm) | Ion conductivity (mS/cm) | Alkali resistance | Dendrite resistance |
| | | | | | | Presence or absence of change in He permeability | Presence or absence of short circuit |
| Example B1^{#} | Al,Ti,Y,In-LDH-like | Mg:0, Al:2, Ti:78, Y:8, In:12 | 0.12 (M=ln) | 0.0 | 3.1 | Absent | Absent |
| Example B2^{#} | Al,Ti,Y,In-LDH-like | Mg:0, Al:1, Ti:56, Y:11, In:32 | 0.32 (M=ln) | 0.0 | 3.1 | Absent | Absent |
| Example B3^{#} | Ti,Y,In-LDH-like | Mg:0, Al:0, Ti:78, Y:8, In:14 | 0.14 (M=ln) | 0.0 | 3.0 | Absent | Absent |
| Example B4^{#} | Mg,Al,Ti,Y,Bi-LDH-like | Mg:2, Al:2, Ti:81 , Y:12, Bi:3 | 0.03 (M=Bi) | 0.0 | 2.9 | Absent | Absent |
| Example B5^{#} | Mg,AI,Ti,Y,Bi-LDH-like | Mg:2, Al:2, Ti:72, Y:10, Bi:14 | 0.14 (M=Bi) | 0.0 | 2.8 | Absent | Absent |
| Example B6^{#} | Mg,Al,Ti,Y,Bi-LDH-like | Mg:1, Al:1, Ti:66, Y:7, Bi:25 | 0.25 (M=Bi) | 0.0 | 2.8 | Absent | Absent |
| Example B7^{#} | Mg,Al,Ti,Y,Ca-LDH-like | Mg:1, Al:3, Ti:73, Y:15, Ca:8 | 0.08 (M=Ca) | 0.0 | 2.8 | Absent | Absent |
| Example B8^{#} | Mg,Al,Ti,Y,Sr-LDH-like | Mg:1, Al:3, Ti:74, Y:14, Sr:8 | 0.08 (M=Sr) | 0.0 | 3.0 | Absent | Absent |
| Example B9^{#} | Al,Ti,Y,Ba-LDH-like | Mg:0, Al:4, Ti:71, Y:14, Ba:11 | 0.11 (M=Ba) | 0.0 | 2.8 | Absent | Absent |
| Example A8* | Mg,Al-LDH | Mg:68 Al:32 | 0 | 0.0 | 2.7 | Present | Present |

Symbol ^{#} represents a reference example.
Symbol * represents a comparative example.

### Examples C1 and C2

Examples C1 and C2 shown below are reference examples for LDH-like compound separators. The method for evaluating the LDH-like compound separators produced in the following examples was the same as in Examples A1 to A8, except that the composition ratio (atomic ratio) of Mg: Al: Ti: Y: In was calculated in Evaluation 3.

### Example C1 (Reference)

### Preparation of Polymer Porous Substrate

A commercially available polyethylene microporous membrane having a porosity of 50%, an average pore diameter of 0.1 µm, and a thickness of 20 µm was prepared as a polymer porous substrate and cut out to a size of 2.0 cm × 2.0 cm.

### Coating of Titania▪ Yttria▪ Alumina Sol on Polymer Porous Substrate

A titanium dioxide sol solution (M6, manufactured by Taki Chemical Co., Ltd.), an yttrium sol, and an amorphous alumina solution (Al-ML15, manufactured by Taki Chemical Co. Ltd.) were mixed so that Ti/(Y + Al) (molar ratio) = 2, and Y/Al (molar ratio) = 8. The substrate prepared in (1) above was coated with the mixed solution by dip coating. The dip coating was carried out by dipping the substrate into 100 ml of the mixed solution, pulling up the coating substrate vertically, and allowing it to dry for 3 hours at room temperature.

### Preparation of Raw Material Aqueous Solution

As the raw materials, magnesium nitrate hexahydrate (Mg(NO₃)₂ ·6H₂O, manufactured by Kanto Chemical Co., Inc.), indium sulfate n-hydrate (In(SO₄)₃ ·nH₂O, manufactured by FUJIFILM Wako Pure Chemicals Corporation), and urea ((NH₂)₂CO, manufactured by Sigma-Aldrich Co. LLC) were prepared. Magnesium nitrate hexahydrate, indium sulfate n-hydrate, and the urea were weighed so as to adjust the concentrations thereof to 0.0075 mol/L, 0.0075 mol/L, and 1.44 mol/L, respectively and placed in a beaker, to which ion-exchanged water was added to make a total volume 75 ml. The resulting solution was stirred to obtain a raw material aqueous solution.

### Membrane Formation by Hydrothermal Treatment

Both the raw material aqueous solution and the dip-coated substrate were sealed in a Teflon® airtight container (autoclave container having a content of 100 ml and an outer side jacket made of stainless steel). At this time, a substrate was fixed while being floated from the bottom of the Teflon® airtight container, and installed vertically so that the solution was in contact with both sides of the substrate. Thereafter, an LDH-like compound was formed on the surface and the inside of the substrate by subjecting it to hydrothermal treatment at a hydrothermal temperature of 120° C. for 22 hours. With an elapse of the predetermined time, the substrate was taken out from the airtight container, washed with ion-exchanged water, and dried at 70° C. for 10 hours to allow for forming of a functional layer including an LDH-like compound and In(OH)₃ inside pores of the porous substrates. Thus, an LDH-like compound separator was obtained.

### Densification by Roll Pressing

The LDH-like compound separator was sandwiched between a pair of PET films (Lumiler® manufactured by Toray Industries, Inc., thickness of 40 µm), and roll-pressed at a roll rotation speed of 3 mm/s, a roller heating temperature of 70° C., and a roll gap of 70 µm to obtain a further densified LDH-like compound separator.

### Evaluation Result

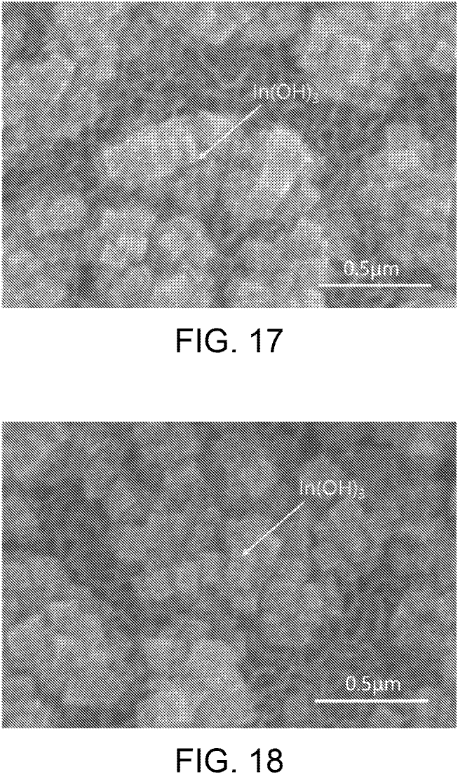

Evaluations 1 to 8 were conducted for the LDH-like compound separators obtained. The results were as follows.
Evaluation 1: The SEM image of surface microstructure of the LDH-like compound separator obtained in Example C1 (before having been roll pressed) was shown in FIG. 17. As shown in FIG. 17, cubic crystals were confirmed to be observed on the surface of the LDH-like compound separator. The results of EDS elemental analysis and X-ray diffraction measurement described below demonstrate that these cubic crystals are presumed to be In(OH)₃.
Evaluation 2: From the observation result of layered lattice stripes, the LDH-like compound separator was confirmed to include a compound with a layered crystal structure.
Evaluation 3: As a result of EDS elemental analysis, the constituent elements of the LDH-like compound or In(OH)₃, which were Mg, Al, Ti, Y, and In were detected on the surface of the LDH-like compound separator. Moreover, in the cubic crystals present on the surface of the LDH-like compound separator, In that was a constituent element of In(OH)₃, was detected. The composition ratio (atomic ratio) of Mg, Al, Ti, Y, and In on the surface of the LDH-like compound separator, calculated by EDS elemental analysis is as shown in Table 3.
Evaluation 4: The peaks in the XRD profile obtained identified that In(OH)₃ was present in the LDH-like compound separator. This identification was conducted using the diffraction peaks of In(OH)₃ listed in JCPDS card No. 01-085-1338.
Evaluation 5: As shown in Table 3, the extremely high denseness was confirmed by a He permeability of 0.0 cm/min▪atm.
Evaluation 6: As shown in Table 3, the high ionic conductivity was confirmed.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 3, the excellent dendrite resistance was confirmed in that there was no short circuit due to zinc dendrites even after 300 cycles.

### Example C2 (Reference)

An LDH-like compound separator was fabricated and evaluated in the same manner as in Example C1 except that the titania-yttria sol coating was carried out as follows instead of (2) above.

### Coating of Titania-Yttria Sol on Polymer Porous Substrate

A titanium dioxide sol solution (M6, manufactured by Taki Chemical Co., Ltd.) and an yttrium sol were mixed so that Ti/Y (molar ratio) = 2. The substrate prepared in (1) above was coated with the obtained mixed solution by dip coating. The dip coating was carried out by dipping the substrate into 100 ml of the mixed solution, pulling up the coating substrate vertically, and allowing it to dry for 3 hours at room temperature.
Evaluation 1: The SEM image of surface microstructure of the LDH-like compound separator obtained in Example C2 (before being roll pressed) is as shown in FIG. 18. As shown in FIG. 18, cubic crystals were confirmed to be observed on the surface of the LDH-like compound separator. The results of EDS elemental analysis and X-ray diffraction measurement described below demonstrate that these cubic crystals are presumed to be In(OH)₃.
Evaluation 2: From the observation result of layered lattice stripes, the LDH-like compound separator was confirmed to include a compound having a layered crystal structure.
Evaluation 3: As a result of EDS elemental analysis, the constituent elements of the LDH-like compound or In(OH)₃, which were Mg, Ti, Y, and In were detected on the surface of the LDH-like compound separator. Moreover, in the cubic crystals on the surface of the LDH-like compound separator, In that is a constituent element of In(OH)₃, was detected. The composition ratio (atomic ratio) of Mg, Ti, Y, and In on the surface of the LDH-like compound separator, calculated by EDS elemental analysis is as shown in Table 3.
Evaluation 4: The peaks in the XRD profile obtained identified that In(OH)₃ was present in the LDH-like compound separator. This identification was conducted using the diffraction peaks of In(OH)₃ listed in JCPDS card No. 01-085-1338.
Evaluation 5: As shown in Table 3, the extremely high denseness was confirmed by a He permeability of 0.0 cm/min▪atm.
Evaluation 6: The high ionic conductivity was confirmed, as shown in Table 3.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 3, no short circuit caused by zinc dendrite occurred even after 300 cycles, confirming the excellent dendrite resistance.

TABLE 3

| | Constitution of functional layer | Composition ratio (atomic ratio relative to 100 of total amount of Mg+Al+Ti+Y+In) | In/(Mg+Al+Ti+Y+In) | Evaluation of hydroxide ion-conductive separator | | | |
|---|---|---|---|---|---|---|---|
| | | | | He permeability (cm/min·atm) | Ion conductivity (mS/cm) | Alkali resistance | Dendrite resistance |
| | | | | | | Presence or absence of change in He permeability | Presence or absence of short circuit |
| Example C1^{#} | LDH-like+ In(OH)₃ | Mg:7, Al:1, Ti:24, Y:3, In:65 | 0.65 | 0.0 | 2.7 | Absent | Absent |
| Example C2^{#} | LDH-like +In(OH)₃ | Mg:6, Al:0, Ti:17, Y:3, In:74 | 0.74 | 0.0 | 2.8 | Absent | Absent |
| Example A8* | LDH | Mg:68, Al:32 | 0 | 0.0 | 2.7 | Present | Present |

Symbol ^{#} represents a reference example.
Symbol * represents a comparative example.

What is claimed is:

1. A secondary zinc battery comprising:
a unit cell comprising;
a positive-electrode plate comprising a positive-electrode active material layer and a positive-electrode collector;
a negative-electrode plate comprising a negative-electrode active material layer and a negative-electrode collector, the negative-electrode active material layer comprising at least one selected from the group consisting of elemental zinc, zinc oxide, zinc alloys, and zinc compounds;
an LDH-like compound separator covering or wrapping around the entire negative-electrode active material layer; the LDH-like compound separator comprising a layered double hydroxide (LDH)-like compound, and
an electrolytic solution,
wherein the positive-electrode active material layer, the negative-electrode active material layer, and the LDH-like compound separator each have a quadrilateral planar shape,
wherein the positive-electrode collector has a positive-electrode collector tab extending from a first edge of the positive-electrode active material layer, and the negative-electrode collector has a negative-electrode collector tab extending from a second edge of the negative-electrode active material layer and beyond a vertical edge of the LDH-like compound separator, the first edge being opposite to the second edge, the unit cell being capable of collecting electricity from the positive-electrode collector tab and the negative-electrode collector tab, the positive-electrode collector tab and the negative-electrode collector tab being disposed at opposite edges of the unit cell, and
wherein the LDH-like compound separator has at least two continuous closed edges, provided that an edge, adjacent to the negative-electrode collector tab, of the LDH-like compound separator is open.

2. The secondary zinc battery according to claim 1, wherein the LDH-like compound is:
(a) a hydroxide and/or an oxide with a layered crystal structure, containing: Mg; and one or more elements, which include at least Ti, selected from the group consisting of Ti, Y, and Al, or
(b) a hydroxide and/or an oxide with a layered crystal structure, comprising (i) Ti, Y, and optionally Al and/or Mg, and (ii) at least one additive element M selected from the group consisting of In, Bi, Ca, Sr, and Ba, or
(c) a hydroxide and/or an oxide with a layered crystal structure, comprising Mg, Ti, Y, and optionally Al and/or In, wherein in (c) the LDH-like compound is present in a form of a mixture with In(OH)₃.

3. The secondary zinc battery according to claim 1, further comprising a liquid retention material disposed between the negative-electrode active material layer and the LDH-like compound separator, the liquid retention material covering or wrapping around the entire negative-electrode active material layer.

4. The secondary zinc battery according to claim 3, wherein the liquid retention material is a non-woven fabric.

5. The secondary zinc battery according to claim 1, wherein the unit cell is disposed such that the positive-electrode plate, the negative-electrode plate, and the LDH-like compound separator are vertically disposed and one closed edge of the LDH-like compound separator resides on the bottom, thereby the positive-electrode collector tab and the negative-electrode collector tab extending laterally from the opposite edges of the unit cell.

6. The secondary zinc battery according to claim 5, wherein the LDH-like compound separator has an open upper edge, or a closed upper edge at which a vent is disposed.

7. The secondary zinc battery according to claim 6, further comprising a case accommodating the unit cell.

8. The secondary zinc battery according to claim 1, further comprising a positive-electrode collector plate connected to an end of the positive-electrode collector tab and a negative-electrode collector plate connected to an end of the negative-electrode collector tab.

9. The secondary zinc battery according to claim 1, wherein there are a plurality of the unit cells accommodated in the case.

10. The secondary zinc battery according to claim 1, wherein the at least two continuous closed edges of the LDH-like compound separator are formed by folding and/or sealing.

11. The secondary zinc battery according to claim 1, wherein the LDH-like compound separator comprises the LDH-like compound and a porous substrate, pores of the substrate being filled with the LDH-like compound, thereby the LDH-like compound separator has hydroxide-ion conductivity and gas-impermeability.

12. The secondary zinc battery according to claim 11, wherein the porous substrate is composed of a polymeric material.

13. The secondary zinc battery according to claim 12, wherein the LDH-like compound is incorporated into the porous substrate over the entire thickness thereof.

14. The secondary zinc battery according to claim 1, wherein the secondary zinc battery is a secondary nickel-zinc battery comprising the positive-electrode active material layer that comprises nickel hydroxide and/or nickel oxyhydroxide.

15. The secondary zinc battery according to claim 1, wherein the secondary zinc battery is a secondary zinc-air battery comprising the positive-electrode active material layer that is an air electrode layer.
